(19) United States
(12) Patent Application Publication
(10) Pub. No.: US 2026/0161845 A1
(43) Pub. Date: Jun. 11, 2026

(54) LARGE-SCALE STORAGE SIMULATION FRAMEWORK FOR HIGH PERFORMANCE COMPUTING (HPC) ENVIRONMENTS

(71) Applicant: THE JOHNS HOPKINS UNIVERSITY, Baltimore, MD (US)

(72) Inventors: Antwan D. CLARK, Pikesville, MD (US); Yu SHAO, Brookline, MA (US); Jiawen BAI, Newark, NJ (US); Giovanni BERRIOS, Catonsville, MD (US); Nicole FLEMING, Catonsville, MD (US)

(21) Appl. No.: 19/111,225

(22) PCT Filed: Sep. 14, 2023
(86) PCT No.: PCT/US2023/032742

§ 371 Date: Mar. 12, 2025

Related U.S. Application Data
(60) Provisional application No. 63/375,609, filed on Sep. 14, 2022.
(60) Provisional application No. 63/382,073, filed on Nov. 2, 2022.

(51) Int. Cl. G06F 30/20; G06F 7/58; G06F 16/182; G06F 113/02

(52) U.S. Cl. CPC G06F 30/20; G06F 7/586; G06F 16/182; G06F 2113/02

(57) ABSTRACT

A method, computer system, and non-transitory computer readable medium is disclosed that comprises instructions to perform the method including initializing a node local burst buffer (“BB”) component, a computer-node component, a parallel file system component, a remote-shared burst buffer component, a node-local BB network configuration, and a remote-shared burst buffer network configuration, determining a rate of data flowing condition to alter between states to control a rate of data flowing through a computer network system; determining a data to move condition to allow data to move from the computer node to the burst buffer or the burst buffer to the parallel file system; determining a simulation condition for a simulation to begin, reset, pause, or terminate; performing a simulation flow using networked compute nodes in a networked simulation; and generating a computer output based on the simulation flow for network analysis.

### CROSS-REFERENCE TO RELATED APPLICATIONS

This application is the national stage entry of International Patent Application No. PCT/US2023/032742, filed on Sep. 14, 2023, and published as WO 2024/059198 A1 on Mar. 21, 2024, which claims the benefit of U.S. provisional application Ser. No. 63/382,073 filed on Nov. 2, 2022 and U.S. provisional application Ser. No. 63/375,609 filed on Sep. 14, 2022, which are hereby incorporated by reference in their entireties.

### GOVERNMENT SUPPORT

This invention was made with government support under contract FA8075-14-D-0002 awarded by the Air Force Research Laboratory and contract S900294BAH awarded by the U.S. Army Research Laboratory. The government has certain rights in the invention.

### FIELD

The present disclosure is directed to high performance computing (HPC), and in particular, to systems and methods for large scale storage simulation framework for HPC environments.

### BACKGROUND

HPC systems transformed the way that information is processed and stored because they can handle vasts amounts of data. However, they also come with the challenge of handling input/output (I/O) bottlenecks due to the following reasons. First, big data applications running in these environments require many read and write operations to handle these workloads and thus consume a lot of I/O bandwidth. Additionally, application-based check pointing and restarting (C/R) is burdensome on the I/O infrastructure because check pointing operations require a myriad number of write requests to the parallel file system (PFS) which also degrade storage server bandwidth. Job heterogeneity is also an issue since job requests of various sizes and priorities compete with each other. This results in prolonged average I/O time because the processing of smaller jobs would be delayed due to the concurrent processing of larger jobs. As a result, the application C/R process is also affected because lower-priority jobs could frequently interrupt the check pointing of higher-priority jobs. Scientists have addressed these concerns by proposing burst buffers (BBs) as brokers via developing infrastructures and algorithms to minimize the effects of I/O contention in supercomputing infrastructures. One approach is to create node-local BB architectures where each burst buffer is collocated with a corresponding compute node. This is advantageous for its scalability while also improving checkpoint bandwidth for the aggregate bandwidth increases proportionally to the number of compute nodes [1], [2], [3], [4]. Since researchers at the San Diego Supercomputer Center (SDSC) illustrated this proof of concept via the DASH supercomputing cluster [5], several current HPCs have adopted these types of storage capabilities including those listed on the Top500 lists [6], [7], [8], [9] (see Table 1). These configurations will also be in future systems like Aurora that is housed at Argonne National Laboratory (ANL) [10].

TABLE 1
Supercomputers (with Node-Local BB Architectures),
Locations, and Top 500 Rankings

| | | Top 500 |
|---|---|---|
| Supercomputer | Location | Ranking |
| Summit | Oak Ridge National Laboratory | 2 |
| Sierra | Lawrence Livermore National Laboratory | 3 |
| TSUBAME 3.0 | Tokyo Institute of Technology | 59 |
| Theta | Argonne National Laboratory | 70 |
| Hyperion | Lawrence Livermore National Laboratory | NR |
| Catalyst | Lawrence Livermore National Laboratory | NR |

Note:
NR = Not Ranked

Another approach is to create remote shared BB architectures, where each BB is shared with multiple compute nodes that is hosted on an I/O node (ION) [4] [6]. This is advantageous for facilitating the independent development, deployment, and maintenance of these architectures, where Table 2 lists supercomputers containing these typologies.

Supercomputers (with Remote-Shared BB Architectures),
Locations, and Top 500 Rankings

| | | Top 500 |
|---|---|---|
| Supercomputer | Location | Ranking |
| Trinity | Los Alamos National Laboratory | 21 |
| Archer 2 | University of Edinburgh | 22 |
| Cori | Lawrence Berkeley National Laboratory | 37 |
| Aurora* | Argonne National Laboratory | NR |

Note*
This supercomputer (planned in late 2022) will have both node-local and remote shared burst buffers (BBs).

There are several resource management products to manage BB architectures. For node-local BB architectures, Bent et al. placed burst buffers into a modified version of the Parallel Log-structured File System (PLFS) middleware. Wang et al. proposed an ephemeral Burst Buffer File System (BurstFS) that manages node-local BBs while also being linearly scalable. Additionally, Tang et al. proposed a proactive draining scheme that manages node-local burst buffers. For remote-shared BB architectures, Kougkas et al. introduced a dynamic scheduler that provides several scheduling policies for shared non-volatile BBs. Pottier et al. have investigated finding methodologies that best suit the utilization of both remote-shared and node-local burst buffers and their limitations. Tang et al. proposed BurstMem that provides a storage framework, on top of Memcached with communication management strategies that demonstrate approximately nine times I/O performance improvement on leadership computer systems. Kougas et al. quantified BB interference measures and proposed an adaptive scheme to handle these occurrences. There are also several commercial solutions to manage remote shared burst buffers. DataWarp employs flash SSD I/O blades with Cray Aires high-speed interconnect, which is designed for Trinity and Cori supercomputers. It has a flexible storage mechanism that is key for reserving BBs, which is easily integrated into the Simple Linux Utility for Resource Management (SLUM) workload manager. Here, users can customize reservations to behave either like file system mounts or local cache layers to effectively support bursty (C/R) workloads. Some BB simulation efforts include Liu et al. who improved the CODES storage system simulator, by adding remote shared BB architectures to IBMs Blue/Gene P framework. Bing et al. quantified the output burst absorption while for the Jaguar supercomputer and modeled system storage behaviors.

Limitations of the above approaches include the following. Although progression has been made in terms of using BBs to mitigate I/O bottlenecks, fully understanding their impacts in an open storage framework is still an open problem. Performance analyses on these architectures has been based on examining I/O behaviors such as I/O bandwidths, lookup times, throughputs, and read and write (R/W) patterns. However, the conclusions drawn from these analyses are limited to certain scenarios at hand and do not directly evaluate the behavior of the burst buffer themselves. Consequently, concerns like stochastic read/write (R/W) behavior, unknown I/O periodicity, and BB strategies (including how they handle dynamic workloads) are not completely considered. Additionally, these storage elements are prone to failures where data is not completely flushed out of the BB within each checkpoint interval and thus will have to wait until the next available interval. The BB simulation tools are not flexible in terms of 1) including a either node-local, remote-shared, or combination of BB architectures in their configuration; 2) do not completely consider the data flows within various BB architectures while considering different use-cases and strategies; 3) are not tunable to assess the effects of certain BB behaviors; 4) do not incorporate the reliability metrics in these systems. The following proposed process addresses these limitations.

Accordingly, techniques are needed to address the above-noted deficiencies of the current approaches.

### SUMMARY

According to examples of the present disclosure a method is disclosed that comprises initializing a node-local burst buffer (“BB”) component, a computer-node component, a parallel file system component, a remote-shared burst buffer component, a node-local BB network configuration, and a remote-shared burst buffer network configuration; determining a rate of data flowing condition to alter between states to control a rate of data flowing through a computer network system; determining a data to move condition to allow data to move from the computer node to the burst buffer or the burst buffer to the parallel file system; determining a simulation condition for a simulation to begin, reset, pause, or terminate; performing a simulation flow using networked compute nodes in a networked simulation; and generating a computer output based on the simulation flow for network analysis.

According to examples of the present disclosure, a computer system is discosed that comprises a hardware processor; a non-transitory computer-readable medium comprising instructions for performing a method comprising: initializing a node-local burst buffer (“BB”) component, a computer-node component, a parallel file system component, a remote-shared burst buffer component, a node-local BB network configuration, and a remote-shared burst buffer network configuration; determining a rate of data flowing condition to alter between states to control a rate of data flowing through a computer network system; determining a data to move condition to allow data to move from the computer node to the burst buffer or the burst buffer to the parallel file system; determining a simulation condition for a simulation to begin, reset, pause, or terminate; performing a simulation flow using networked compute nodes in a networked simulation; and generating a computer output based on the simulation flow for network analysis.

According to examples of the present disclosure, a non-transitory computer-readable medium is disclosed that comprises instructions for performing a method comprises initializing a node-local burst buffer (“BB”) component, a computer-node component, a parallel file system component, a remote-shared burst buffer component, a node-local BB network configuration, and a remote-shared burst buffer network configuration; determining a rate of data flowing condition to alter between states to control a rate of data flowing through a computer network system; determining a data to move condition to allow data to move from the computer node to the burst buffer or the burst buffer to the parallel file system; determining a simulation condition for a simulation to begin, reset, pause, or terminate; performing a simulation flow using networked compute nodes in a networked simulation; and generating a computer output based on the simulation flow for network analysis.

According to examples of the present disclosure the method can include one or more of the following features. The node-local burst buffer component is initialized with a user provided system clock rate, bandwidth values for connection to the compute node and parallel file system, max capacity, starting load, threshold, scaling option, scaling rate. The computer-node component is initialized with a user provided system clock rate, random number generator seeds, bandwidth values for connection to the burst buffer, the rate that data flows into the burst buffer from the compute node (CN), the rate that data leaves the burst buffer to the parallel file system (PFS) representing permanent storage, the intermediate time intervals and the number of times that the content flows from the compute node to the BB, the intermediate time intervals and the number of times that the content flows the BB to the PFS. The parallel file system component is initialized with a user provided system clock rate. The remote-shared burst buffer component is initialized with a user-defined number of CNs, system clock rate, bandwidth values from the CNs to the BB, bandwidth values from the BB to the PFS, BB max capacity, BB starting load, BB threshold, a scaling option, and a scaling rate. The node-local BB network configuration is initialized with a user provided network topology, network size, network configuration, link bandwidth, link latency, flit size, bandwidth, input latency, output latency, input buffer size, output buffer size, and message size. The remote-shared BB network configuration is initialized with a user provided network topology, network size, network configuration, link bandwidth, link latency, flit size, bandwidth, input latency, output latency, input buffer size, output buffer size, and message size. The performing uses a multiply-with-carry pseudo random number generator with an exponential distribution for determining when to alter between states to control the rate of data flowing through the system. The pseudo random number generator is a Marsaglia-based random number generator. The performing uses a two-state cycle to determine when to allow data to move from the compute node to the burst buffer, or the burst buffer to the parallel file system at a rate equal to the bandwidth available between the communicating components. The performing uses the node-local BB to dictate simulation flow in its node-local simulation by determining when the simulation can begin, reset, pause, and terminate. The performing uses the remote-shared BB to dictate simulation flow in its node-local simulation by determining when the simulation can begin, reset, pause, and terminate. The computer output comprises one or more of the following: one or more computer generated displays that show a capacity at an end of each simulation to a user along with statistics on how often systems threshold was exceeded and for how long the threshold was exceeded for a duration of the simulation; a file with a new-line delimiter of values that represent a reliability rate of the burst buffer at an end of programs runtime; a file with a new-line delimiter of values that represent a load of the burst buffer throughout one simulation; a file with a new-line delimiter of values for how often the simulation is in a compute state while under a user defined threshold; a file with a new-line delimiter of values for how often the simulation is in an I/O state and while under the user defined threshold; or a file with a comma delimiter of values representing a rate that data flows into the burst buffer from the compute node (CN), a rate that data leaves the burst buffer to a parallel file system (PFS).

### BRIEF DESCRIPTION OF THE FIGURES

FIG. 1 shows a simple burst buffer configuration according to examples of the present disclosure.

FIG. 2 shows an example Burst Buffer Configuration [node-local] according to examples of the present disclosure.

FIG. 3 shows an example simple Burst Buffer Configuration [node-local] according to examples of the present disclosure where initialization is required to set up the parameters of the BB simulation, such that some are defined when the user initializes the simulation configuration and others require individual set up.

FIG. 4 shows an example simple Burst Buffer Configuration [node-local] according to examples of the present disclosure.

FIG. 5A and FIG. 5B show an example simple Burst Buffer Configuration [node-local] according to examples of the present disclosure.

FIG. 6 shows an example output BB initialization, CN initialization, and FPS initialization according to examples of the present disclosure.

FIG. 7 shows an example Simple Burst Buffer Configuration for Node-Local Configuration Logic Flow according to examples of the present disclosure.

FIG. 8 shows an example of a simple Burst Buffer configuration for a remote shared configuration simulation setup according to examples of the present disclosure.

FIG. 9 shows an example Simple Burst Buffer Configuration for Remote-Shared Configuration Simulation Setup according to examples of the present disclosure.

FIG. 10 shows an example network configuration according to examples of the present disclosure.

FIG. 11 shows an example simple Burst Buffer configuration for a network configuration setup according to examples of the present disclosure.

FIG. 12 shows an example simple Burst Buffer configuration for a network configuration setup according to examples of the present disclosure.

FIG. 13 shows an example simple Burst Buffer configuration for a network configuration setup according to examples of the present disclosure.

FIG. 14 shows an example simple Burst Buffer configuration for a network configuration setup according to examples of the present disclosure.

FIG. 15 shows an example of a simple Burst Buffer Configuration for a network configuration setup 1500 according to examples of the present disclosure.

FIG. 16 shows an example of a simple Burst Buffer configuration for a reading adjacency list file according to examples of the present disclosure.

FIG. 17A and FIG. 17B show an example of a simple Burst Buffer configuration for a network finishGraph( ) function according to examples of the present disclosure.

FIG. 18 shows an example of a simple Burst Buffer configuration for a network routing table according to examples of the present disclosure.

FIG. 19 shows an example of a simple Burst Buffer configuration for a network routing table according to examples of the present disclosure.

FIG. 20 shows an example of a simple Burst Buffer configuration for a network Dijkstra's steps 1-3 according to examples of the present disclosure.

FIG. 21 shows an example of a simple Burst Buffer configuration for a network Dijkstra's steps 4-6 according to examples of the present disclosure.

FIG. 22 shows an example of a simple Burst Buffer configuration for a network updating routing table according to examples of the present disclosure.

FIG. 23 shows an example of a simple Burst Buffer configuration for a network updating routing table according to examples of the present disclosure.

FIG. 24 shows an example of a simple Burst Buffer configuration for a network updating routing table according to examples of the present disclosure.

FIG. 25 shows an example function pointer and network function for a simple Burst Buffer configuration for a network to Large Scale Storage and Simulation (L-S3) framework connection according to examples of the present disclosure.

FIG. 26 shows an example function forwarder according to examples of the present disclosure.

FIG. 27A and FIG. 27B show an example of a simple Burst Buffer configuration for a network to L-S3 framework connection according to examples of the present disclosure.

FIG. 28A and FIG. 28B show an example of a simple Burst Buffer configuration for a network to L-S3 framework connection according to examples of the present disclosure.

FIG. 29 shows an example of a simple Burst Buffer configuration for a network to L-S3 framework connection according to examples of the present disclosure.

FIG. 30A and FIG. 30B show an example of data output for L-S3 framework data output according to examples of the present disclosure.

FIG. 31 shows example data output files where the L-S3 Framework has two output forms where the first output is information transmitted directly to the user via the terminal and the second are data files created for users to use as needed according to examples of the present disclosure.

FIG. 32A and FIG. 32B shows an example of a functionality for threshold checking according to examples of the present disclosure.

FIG. 33 shows an example of a data output for flagging routers approach according to examples of the present disclosure.

FIG. 34 shows an example of a data output for a front-load routers method according to examples of the present disclosure.

FIG. 35 shows an example of component functionality features according to examples of the present disclosure.

FIG. 36 shows an example of network functionality features according to examples of the present disclosure.

FIG. 37 shows an example of a threshold scaling feature according to examples of the present disclosure.

FIG. 38 shows an example of a threshold scaling feature according to examples of the present disclosure.

FIG. 39 shows an example of a threshold scaling feature with a down scaling option according to examples of the present disclosure.

FIG. 40 shows an example of a threshold scaling feature with an up and down scaling option according to examples of the present disclosure.

FIG. 41A, FIG. 41B, and FIG. 41C show an example of L-S3 single node local results according to examples of the present disclosure.

FIG. 42A, FIG. 42B, and FIG. 42C show an example of L-S3 network node local results according to examples of the present disclosure.

FIG. 43 shows example results (L-S3 vs theoretical) according to examples of the present disclosure.

FIG. 44 shows example results (SST vs theoretical) according to examples of the present disclosure.

FIG. 45 shows example results (L-S3 vs SST) according to examples of the present disclosure.

FIG. 46 shows a plot of power and asymptotic expansions of the Bessel function I₀.

FIG. 47 illustrates an example of such a computing system, in accordance with some embodiments.

### DETAILED DESCRIPTION

An agnostic simulation framework, which can be integrated with other commercial discrete event simulators, emulates the data flows within various combinations of HPC storage architectures containing node-local burst buffers (BBs), remote-shared BBs, or a combination of both is disclosed. Performance analysis metrics are also provided for wide varieties of node-local BBs within each checkpoint interval. One benefit to this technology is that this can simulate multiple use-case scenarios for better planning and tool development.

Generally speaking, examples of the present disclosure provide for simulation of real-time data flows of intermediate (temporary) storage systems in HPC environments containing node-local and/or remote-shared burst buffers (BBs). This is applicable to examine various resource allocation use-cases (e.g., input/output (I/O) bottlenecks, resource allocation interference, etc.) affecting these architectures.

This simulation is flexible and can be used for heterogeneous or varied HPC storage architectures. Hence, users can adapt this simulation framework for their specific use-cases and architectures. A performance analysis framework is also provided for the case of intermediate storage elements containing only node-local BB architectures, where these analysis individually consider the performance BBs within each checkpoint intervals.

Robustly analyzing the reliability of intermediary storage architectures is still an open problem, where this is of great interest to the HPC community. Previous only focus on the placement of these architectures to improve overall input/output (I/O) performance; however, they do not investigate the reliability of these intermediate storage architectures themselves, where they are also prone to failures and the current state-of-the-art approaches do not consider this.

This technology will be integrated into the Structural Simulation Toolkit (SST) by Sandia National Laboratory (SNL), where collaborations are being prepared with Tactical Computing Laboratories to integrate this module into SST. SST has already been shared within the HPC community, where various academic, commercial, and government entities have used this software for various simulation purposes.

### Large-Scale Storage Simulation Framework for HPC Environments

HPCs are continuing to transition to exascale

Large scale storage architectures are being integrated into these systems primarily used to mitigate the effects of I/O contention.

These architectures can be divided into the following categories: 1. Node-Local Based Storage Architectures—These contain node-local intermediary storage (e.g., SSDs, DRAMs) that collocate with each compute nodes; 2. Remote-Shared Based Storage Architectures—These contain intermediary storage that is shared across multiple compute nodes (CNs); and 3. Mixed Based Storage Architectures—These contain a mixture of node-local and remote-shared architectures.

$${λ}_{12} = Lambda - Transition rate for compute node transition from \\ \\ compute phase to I / O phase$$

$${λ}_{21} = Mu - Transition Rate for compute node transition from I / O phase \\ \\ to compute phase$$

$${ϕ}_{1} = Phi 1 - Flow rate / Bandwidth from Burst Buffer to Parallel File \\ \\ System$$

$${ϕ}_{2} = Phi 2 - Flow rate / Bandwidth from Compute Node to Burst Buffer$$

rᵢ-Data rates entering and leaving the burst buffer
Q(t)—The load of the burst buffer at time t.

These architectures demonstrate improvement in overall I/O performance. However, the performance analysis only considers this from a macro perspective.

Moreover, these intermediary storage elements are prone to failures where the data flows within these devices are based on several factors including: stochastic read/write (R/W) behavior; unknown I/O periodicity; how these storage elements handle workloads; and understanding failures.

Therefore, there is a need for simulation tools that emulate intermediate storage architectures within HPC environments while understanding their reliability (and performance) on various micro levels.

According to examples of the present disclosure, benefits of the disclosed methods and/systems can include, but are not limited to, providing researchers and technicians the ability to develop “storage-based” use cases and providing direct performance analysis of node-local architectures within these environments.

The present agnostic simulation framework that emulates the data flows within various combinations of HPC storage architectures containing node-local BBs, remote-shared BBs, or a combination of both comprising of the following feature.

### Initialization

1. Initializes the node-local burst buffer component with a user provided system clock rate, bandwidth values for connection to the compute node and parallel file system, max capacity, starting load, threshold, scaling option, scaling rate.
2. Initializes the compute node component with a user provided system clock rate, random number generator seeds, bandwidth values for connection to the burst buffer, the rate that data flows into the burst buffer from the compute node (CN), the rate that data leaves the burst buffer to the parallel file system (PFS) representing permanent storage, the intermediate time intervals and the number of times that the content flows from the compute node to the BB, the intermediate time intervals and the number of times that the content flows the BB to the PFS.
3. Initializes the parallel file system component with a user provided system clock rate.
4. Initializes a remote-shared burst buffer component with a user-defined number of CNs, system clock rate, bandwidth values from the CNs to the BB, bandwidth values from the BB to the PFS, BB max capacity, BB starting load, BB threshold, a scaling option, and a scaling rate.
5. Initializes node-local BB network configurations with a user provided network topology, network size, network configuration, link bandwidth, link latency, flit size, bandwidth, input latency, output latency, input buffer size, output buffer size, and message size.
6. Initializes remote-shared BB network configurations with a user provided network topology, network size, network configuration, link bandwidth, link latency, flit size, bandwidth, input latency, output latency, input buffer size, output buffer size, and message size.

### Utilization/Configuration

7. Utilizes a multiply-with-carry pseudo random number generator (i.e., a Marsaglia-based random number generator) with an exponential distribution for determining when to alter between states to control the rate of data flowing through the system.
8. Utilizes a two-state cycle to determine when to allow data to move from the compute node to the burst buffer, or the burst buffer to the parallel file system at a rate equal to the bandwidth available between the communicating components.
9. Utilizes the node-local BB to dictate simulation flow in its node-local simulation by determining when the simulation can begin, reset, pause, and terminate.
10. Utilizes the remote-shared BB to dictate simulation flow in its node-local simulation by determining when the simulation can begin, reset, pause, and terminate.
11. Utilizes the networked compute nodes to dictate simulation flow in the networked simulation by determining when the simulation can begin, reset, pause, and terminate based on the current progress of all compute nodes within the network.
10. Utilizes a multiply-with-carry pseudo random number generator (i.e., a Marsaglia-based random number generator) with an exponential distribution for determining when to alter between states to control the rate of data flowing through the system.
11. Utilizes a two-state cycle to determine when to allow data to move from the compute node to the burst buffer, or the burst buffer to the parallel file system at a rate equal to the bandwidth available between the communicating components.
12. Utilizes the networked compute nodes to dictate simulation flow in the networked simulation by determining when the simulation can begin, reset, pause, and terminate based on the current progress of all compute nodes within the network.

### Management

1. Manages the rate of data delivery to components based on the maximum allowable bandwidth available and the current contents of the burst buffer.
2. Manages the system during an overflow by pausing compute nodes and allowing the burst buffer to clear its contents by forwarding it to the parallel file system.
3. Manages threshold tolerance on the burst buffer by allowing for real time adjustment through the simulation based on user configuration preferences.

### Additional Capabilities

1. Resets the burst buffer component to its starting state to allow for a new simulation to be ran with the same parameters provided by the user.
2. Resets the compute node components to its starting state with a new random generator seed to allow for a new simulation to be ran with the same parameters provided by the user, excluding the original seed.
   i. The new seed is obtained by the following equation: Original Seed+Simulation Number−1 where the Simulation starts from the initialization step.
3. Resets the parallel file system component to its initial state before any simulation has been ran but after all the initial user provided values have been instantiated.

### Output

1. Displays the capacity at the end of each simulation to the user along with statistics (metrics) on how often the systems threshold was exceeded and for how long the threshold was exceeded for the duration of the simulation.
2. Provide user with a file, such as a .csv file, with a new-line delimiter of values that represent the reliability rate of the burst buffer at the end of the programs runtime.
3. Provide user with a file, such as a .csv file, with a new-line delimiter of values that represent the load of the burst buffer throughout one simulation.
4. Provide user with a file, such as a .csv file, with a new-line delimiter of values for how often the simulation is in the compute state while under the user defined threshold.
5. Provide user with a file, such as a .csv file, with a new-line delimiter of values for how often the simulation is in the I/O state and while under the user defined threshold.
6. Provide user with a file, such as a .csv file, with a comma delimiter of the values representing the rate that data flows into the burst buffer from the compute node (CN), the rate that data leaves the burst buffer to the parallel file system (PFS).

### Node-Local BB Metrics

For node-local BB configurations, the metrics are comprised of the following:
1. Models the statistical reliability function of the BB in terms of the BB not exceeding a certain threshold value (this threshold is determined by HPC systems administrators (SAs)) for the case when the BB is initially empty at the beginning of each checkpoint when the magnitudes of the input flow data rate and the drain data rate are either equal or not equal.
2. Models the statistical failure distribution of the BB in terms of when the BB does exceed a particular threshold value (this threshold is determined by HPC systems administrators (SAs)) for the case when the BB is initially empty at the beginning of each checkpoint interval and the magnitudes of the input flow data rates and drain data rates are either equal or not equal.
3. Models the statistical reliability function of the BB in terms of the BB not exceeding a certain threshold value (this threshold is determined by HPC systems administrators (SAs)) for the case when the BB is initially non-empty at the beginning of each checkpoint interval and the magnitudes of the input flow data rates and drain data rates are equal.
4. Models the statistical failure distribution of the BB in terms of the BB exceeding a certain threshold value (this threshold is determined by HPC systems administrators (SAs)) for the case when the BB is initially non-empty at the beginning of each checkpoint interval and the magnitudes of the input flow data rates and drain data rates are equal.
5. Models the instantaneous reliability function (also known as the hazard rate) with respect to changes in the threshold value (determined by HPC SAs) for the case when the BB is initially empty at the beginning of each checkpoint interval and the magnitudes of the input flow data rates and drain data rates are either equal or not equal.
6. Models the instantaneous reliability function (also known as the hazard rate) with respect to changes in the threshold value (determined by HPC SAs) for the case when the BB is initially nonempty at the beginning of each checkpoint interval and the magnitudes of the input flow data rates and drain data rates are equal.
7. Models the statistical conditional distribution of the BB not exceeding a certain threshold value (determined by HPC SAs) for the case when the BB is initially empty at the beginning of each checkpoint when the magnitudes of the input flow data rate and the drain data rate are either equal or not equal whenever the data flows from the compute node to the BB.
8. Models the statistical conditional distribution of the BB not exceeding a certain threshold value (determined by HPC SAs) for the case when the BB is initially empty at the beginning of each checkpoint when the magnitudes of the input flow data rate and the drain data rate are either equal or not equal whenever the data flows from the BB to the PFS.
9. Models the statistical conditional distribution of the BB not exceeding a certain threshold value (determined by HPC SAs) for the case when the BB is initially non-empty at the beginning of each checkpoint when the magnitudes of the input flow data rate and the drain data rate are equal whenever the data flows from the compute node to the BB.
10. Models the statistical conditional distribution of the BB not exceeding a certain threshold value (determined by HPC SAs) for the case when the BB is initially non-empty at the beginning of each checkpoint when the magnitudes of the input flow data rate and the drain data rate are equal whenever the data flows from the BB to the PFS.
11. Approximates the statistical reliability function of the BB in terms of the BB not exceeding a certain threshold value (determined by HPC SAs) for the case when the BB is initially empty at the beginning of each checkpoint when the magnitudes of the input flow data rate and the drain data rate are either equal or not equal.
12. Approximates the statistical failure distribution of the BB in terms of when the BB does exceed a particular threshold value (determined by HPC SAs) for the case when the BB is initially empty at the beginning of each checkpoint interval and the magnitudes of the input flow data rates and drain data rates are either equal or not equal.
13. Approximates the statistical reliability function of the BB in terms of the BB not exceeding a certain threshold value (determined by HPC SAs) for the case when the BB is initially non-empty at the beginning of each checkpoint interval and the magnitudes of the input flow data rates and drain data rates equal.
14. Approximates the statistical failure distribution of the BB in terms of the BB exceeding a certain threshold value (determined by HPC SAs) for the case when the BB is initially non-empty at the beginning of each checkpoint interval and the magnitudes of the input flow data rates and drain data rates are equal.
15. Approximates the statistical conditional distribution of the BB not exceeding a certain threshold value (determined by HPC SAs) for the case when the BB is initially empty at the beginning of each checkpoint when the magnitudes of the input flow data rate and the drain data rate are either equal or not equal whenever the data flows from the compute node to the BB.
16. Approximates the statistical conditional distribution of the BB not exceeding a certain threshold value (determined by HPC SAs) for the case when the BB is initially empty at the beginning of each checkpoint when the magnitudes of the input flow data rate and the drain data rate are either equal or not equal whenever the data flows from the BB to the PFS.
17. Approximates the statistical conditional distribution of the BB not exceeding a certain threshold value (determined by HPC SAs) for the case when the BB is initially non-empty at the beginning of each checkpoint when the magnitudes of the input flow data rate and the drain data rate are equal whenever the data flows from the compute node to the BB.
18. Approximates the statistical conditional distribution of the BB not exceeding a certain threshold value (determined by HPC SAs) for the case when the BB is initially non-empty at the beginning of each checkpoint when the magnitudes of the input flow data rate and the drain data rate are equal whenever the data flows from the BB to the PFS.
19. Estimates the statistical reliability function of the BB in terms of the BB not exceeding a certain threshold value (determined by HPC SAs) for the case when the BB is initially empty at the beginning of each checkpoint when the magnitudes of the input flow data rate and the drain data rate are either equal or not equal.
20. Estimates the statistical failure distribution of the BB in terms of when the BB does exceed a particular threshold value (determined by HPC SAs) for the case when the BB is initially empty at the beginning of each checkpoint interval and the magnitudes of the input flow data rates and drain data rates are either equal or not equal.
21. Estimates the statistical reliability function of the BB in terms of the BB not exceeding a certain threshold value (determined by HPC SAs) for the case when the BB is initially non-empty at the beginning of each checkpoint interval and the magnitudes of the input flow data rates and drain data rates equal.
22. Estimates the statistical failure distribution of the BB in terms of the BB exceeding a certain threshold value (determined by HPC SAs) for the case when the BB is initially non-empty at the beginning of each checkpoint interval and the magnitudes of the input flow data rates and drain data rates are equal.
23. Estimates the statistical conditional distribution of the BB not exceeding a certain threshold value (determined by HPC SAs) for the case when the BB is initially empty at the beginning of each checkpoint when the magnitudes of the input flow data rate and the drain data rate are either equal or not equal whenever the data flows from the compute node to the BB.
24. Estimates the statistical conditional distribution of the BB not exceeding a certain threshold value (determined by HPC SAs) for the case when the BB is initially empty at the beginning of each checkpoint when the magnitudes of the input flow data rate and the drain data rate are either equal or not equal whenever the data flows from the BB to the PFS.
25. Estimates the statistical conditional distribution of the BB not exceeding a certain threshold value (determined by HPC SAs) for the case when the BB is initially non-empty at the beginning of each checkpoint when the magnitudes of the input flow data rate and the drain data rate are equal whenever the data flows from the compute node to the BB.
26. Estimates the statistical conditional distribution of the BB not exceeding a certain threshold value (determined by HPC SAs) for the case when the BB is initially non-empty at the beginning of each checkpoint when the magnitudes of the input flow data rate and the drain data rate are equal whenever the data flows from the BB to the PFS.
27. Performs error comparisons (analysis) between the models, the approximations, and the estimations of the statistical reliability function of the BB in terms of the BB not exceeding a certain threshold value (determined by HPC SAs) for the case when the BB is initially empty at the beginning of each checkpoint when the magnitudes of the input flow data rate and the drain data rate are either equal or not equal.
28. Performs error comparisons between the models, the approximations, and the estimations of the statistical failure distribution of the BB in terms of when the BB does exceed a particular threshold value (determined by HPC SAs) for the case when the BB is initially empty at the beginning of each checkpoint interval and the magnitudes of the input flow data rates and drain data rates are either equal or not equal.
29. Performs error comparisons between the models, the approximations, and the estimations of the statistical reliability function of the BB in terms of the BB not exceeding a certain threshold value (determined by HPC SAs) for the case when the BB is initially non-empty at the beginning of each checkpoint interval and the magnitudes of the input flow data rates and drain data rates equal.
30. Performs error comparisons between the models, the approximations, and the estimations of the statistical failure distribution of the BB in terms of the BB exceeding a certain threshold value (determined by HPC SAs) for the case when the BB is initially non-empty at the beginning of each checkpoint interval and the magnitudes of the input flow data rates and drain data rates are equal.
31. Performs error comparisons between the models, the approximations, and the estimations of the statistical conditional distribution of the BB not exceeding a certain threshold value (determined by HPC SAs) for the case when the BB is initially empty at the beginning of each checkpoint when the magnitudes of the input flow data rate and the drain data rate are either equal or not equal whenever the data flows from the compute node to the BB.
32. Performs error comparisons between the models, the approximations, and the estimations of the statistical conditional distribution of the BB not exceeding a certain threshold value (determined by HPC SAs) for the case when the BB is initially empty at the beginning of each checkpoint when the magnitudes of the input flow data rate and the drain data rate are either equal or not equal whenever the data flows from the BB to the PFS.
33. Performs error comparisons between the models, the approximations, and the estimations of the statistical conditional distribution of the BB not exceeding a certain threshold value (determined by HPC SAs) for the case when the BB is initially non-empty at the beginning of each checkpoint when the magnitudes of the input flow data rate and the drain data rate are equal whenever the data flows from the compute node to the BB.
34. Performs error comparisons between the models, the approximations, and the estimations of the statistical conditional distribution of the BB not exceeding a certain threshold value (determined by HPC SAs) for the case when the BB is initially non-empty at the beginning of each checkpoint when the magnitudes of the input flow data rate and the drain data rate are equal whenever the data flows from the BB to the PFS.
35. Method is available for any number of compute nodes (and network configurations).

The present disclosure additional provides for the following features.
1. To provide the comparison between the simulative output (representing the actual information within a checkpoint/restart (C/R) interval) and the analytical solution (known as the theoretical) in terms of the likelihood that the burst buffer (also known as the non-volatile random-access memory) is able to process information within a given threshold.
   a. Note #1: The non-volatile random-access memory is also known as the solid-state drive (SSD) or dynamic random-access memory (DRAM).
   b. Note #2: The analytical solution is the exact solution that describes the likelihood of any node-local burst buffer (BB) handing the jobs. This considers the following cases:
      i. When the BB is initially empty at the start of each C/R interval.
      ii. When the BB is initially non-empty at the start of each C/R interval.
      iii. Note: This is described in Slide 1 of the supplemental slides.
2. To provide the comparison between the approximate output (representing the actual information within a checkpoint/restart (C/R) interval) and the approximate solution in terms of the likelihood that the burst buffer (also known as the non-volatile random-access memory) is able to process information within a given threshold.
   a. Note #1: This approximate solution only considers the leading terms of the power series and asymptotic series representations of the solutions of the equations.
      i. Note #1A: This is for all of the terms containing the modified Bessel functions.
3. To provide the comparison between the approximate output (representing the actual information within a checkpoint/restart (C/R) interval) and the approximate solution in terms of the likelihood that the burst buffer (also known as the non-volatile random-access memory) is able to process information within a given threshold.
   a. Note #1: This approximate solution only considers the first two terms of the respective power series and asymptotic series representations of the solutions of the equations.
      i. Note #1A: This is for all of the terms containing the modified Bessel functions.
4. For the case when the initial content is less than or equal to the threshold (i.e., when u<=x), the comparisons are only between the actual and the theoretical solutions of this.

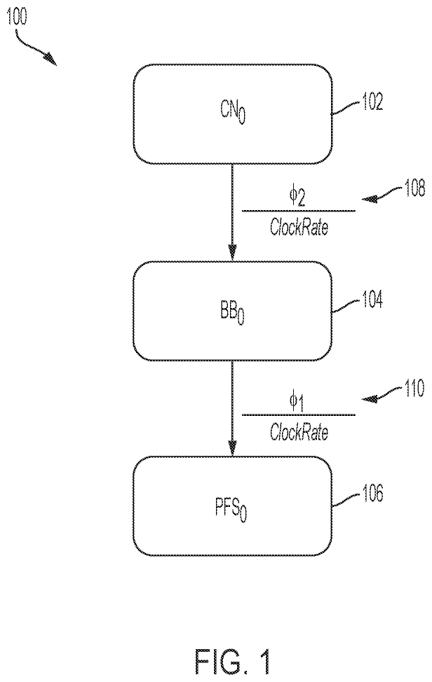

FIG. 1 shows a simple burst buffer configuration 100 according to examples of the present disclosure. Node-Local Configuration Overview. Three components include Compute Node (CN) 102, Burst Buffer (BB) 104, and Parallel File System (PFS) 106. Each Compute Node is attached to its own private Burst Buffer. Data flows from the CN to the BB. Status codes* are supplied to CN from BB. All Burst Buffers are connected to a singular PFS. Data flows from BB to the PFS. Status codes* are supplied to PFS from BB. Status codes are responsible for informing components when to enact special commands such as pausing a component or resetting a component. As shown in FIG. 1, data from CN₀ 102 and ClockRate φ₂ flows to BB₀ 104. Data from BB₀ 104 and ClockRate φ₁ 110 flows to PFS₀ 106.

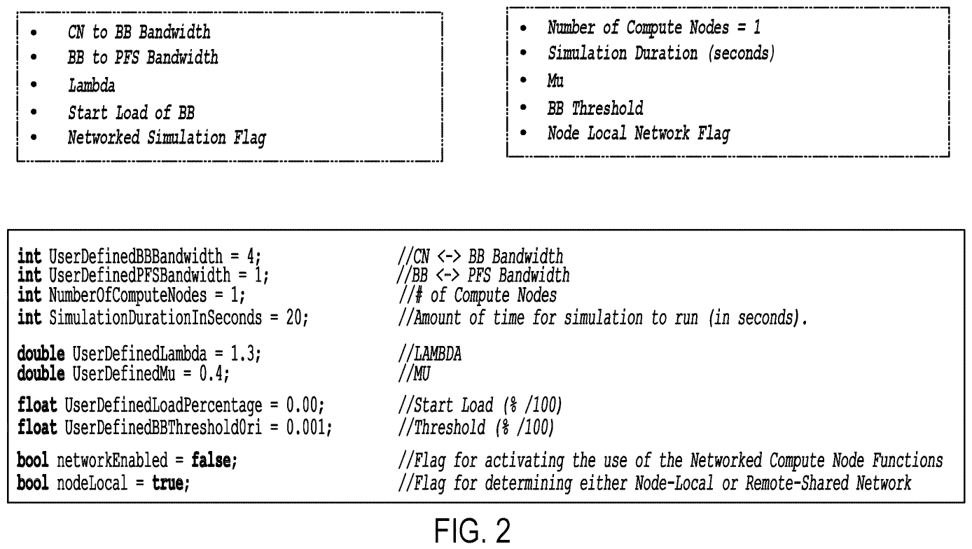

FIG. 2 shows an example Burst Buffer Configuration [node-local] according to examples of the present disclosure. As shown in FIG. 2, a user defines variables that effect all simulations including the following variables: CN to BB bandwidth, BB to PFS bandwidth, lambda, start load of BB, networked simulation flag, number of compute nodes=1, simulation duration (seconds), Mu, BB threshold, and node local network flag. In this example, the CN to BB bandwidth is given by “UserDefinedBBBandwidth=4,” the BB to PFS bandwidth is given by “UserDefinedPFSBandwidth=1, the number of compute nodes is given by “NumberofComputeNodes=1,” the simulation duration in seconds is given by “SimulationDurationInSeconds=20,” the lambda variable is defined by “UserDefinedLambda=1.3,” the Mu variable is defined by “UserDefinedMu=0.4,” where both lambda and Mu determines the switch rate, the burst buffer (BB) start load is defined in floating point by “UserDefinedLoadPercentage=0.00,” the burst buffer (BB) threshold is defined in floating point by “UserDefinedBBThreshold0r1=0.001,” the network simulation flag is defined by “networkEnabled=false,” and the node-local network flag is defined by “nodeLocal=true,” where the flags are used to indicate performing network simulation is included in the L-S3 framework and both flags are only used to indicate that the data rates depend on the network.

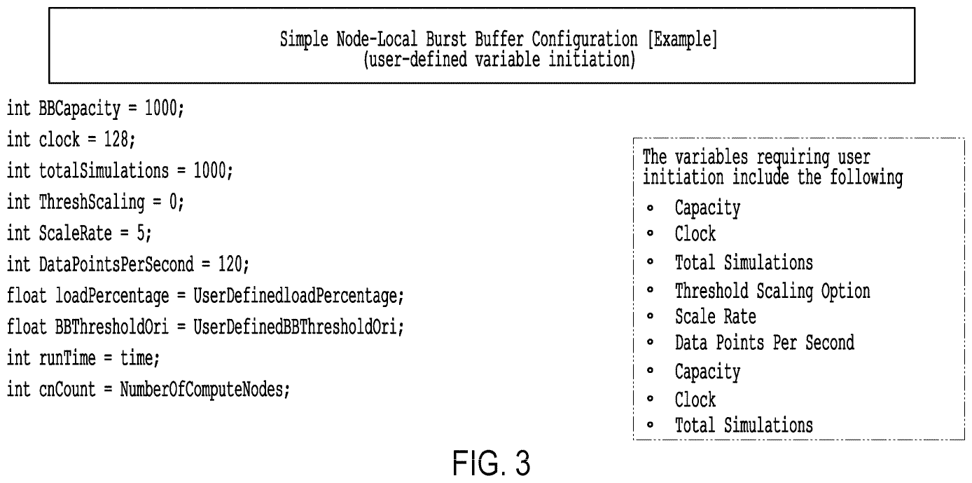

FIG. 3 shows an example simple Burst Buffer Configuration [node-local] where initialization is required to set up the parameters of the BB simulation, such that some are defined when the user initializes the simulation configuration and others require individual set up. The variables that require the user to initialize include the following: Capacity, Clock, Total Simulations, Threshold Scaling Option, Scale Rate, and data points per second. This example also shows that the BB max capacity, BB clock rate, and total number of simulations as defined by the user. In this example, the BB max capacity is given by “BBCapacity=1000,” the BB clock rate is given by “clock=128,” the total number of simulations is given by “totalSimulations=1000,” the threshold scaling type is given by “ThreshScaling=0,” the rate of scaling rate is given by “ScaleRate=5,” the data points per second which determines how many datapoints to capture per second of simulation is given by “DataPointsPerSecond=128.” The values for “loadPercentage,” BBThresholdOri,” BBBandwidth,” “PFSBandwidth,” “runTime,” and “cnCount” (number of compute nodes) can be defined as part of the simulation configuration.

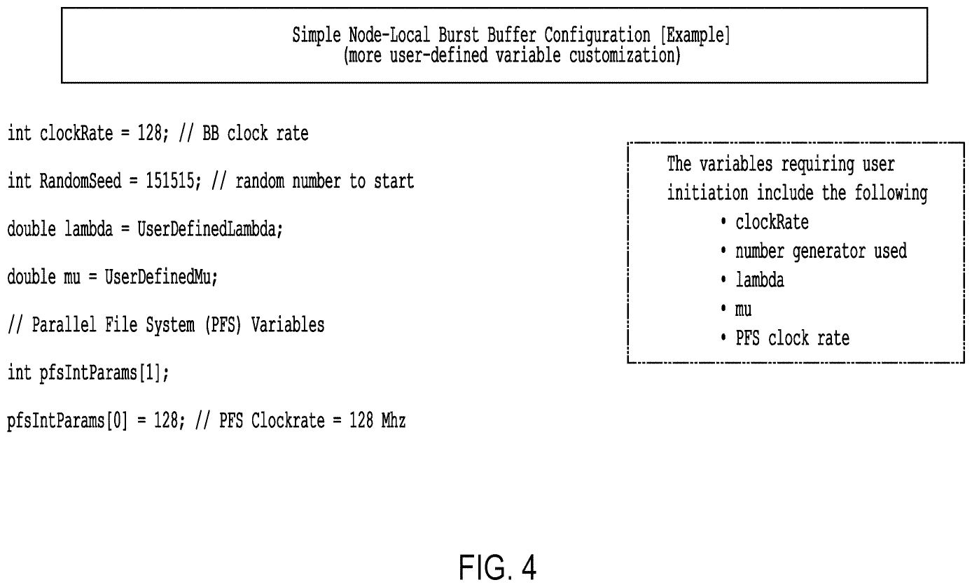

FIG. 4 shows an example simple Burst Buffer Configuration [node-local] according to examples of the present disclosure where initialization is required to set up the parameters of the BB simulation, such that some are defined when the user initializes the simulation configuration and others require individual set up. The variables that require the user to initialize include the following: Clock Rate and Number Generator Seed. This example also shows that the Clock Rate and Number Generator Seed, as defined by the user, where the user defines what seed to start the random number generator and the clock rate of the burst buffer. In this example, the clock rate is given by “clockRate=128” and the random number generator seed is given by “RandomSeed=151515.” Also, in this example, lambda and Mu have been previously defined; hence, those values are used here. Also shown in FIG. 4, the simple burst Buffer Configuration [node-local] parallel file system (PFS) setup is shown where the user defines variables required by the different components, such that some are defined as part of the simulation configuration and others are not needed to be provided. Some customized variables include the following: Clock Rate. This example also shows that the Clock Rate, as defined by the user, for the parallel file system (PFS) is provided. As shown, the clock rate for the parallel file system (PFS) is given by “pfsIntParams [0]=128.”

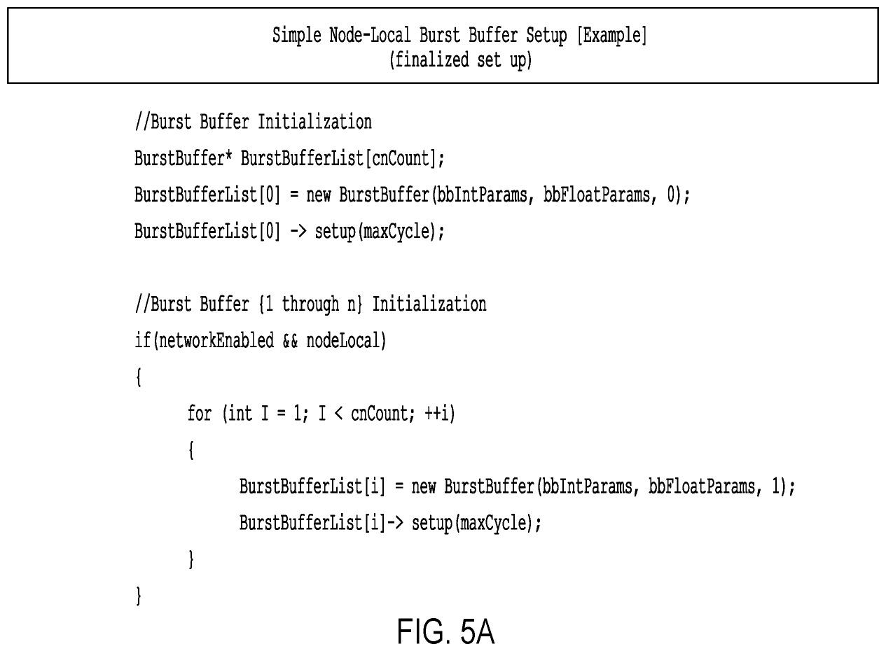

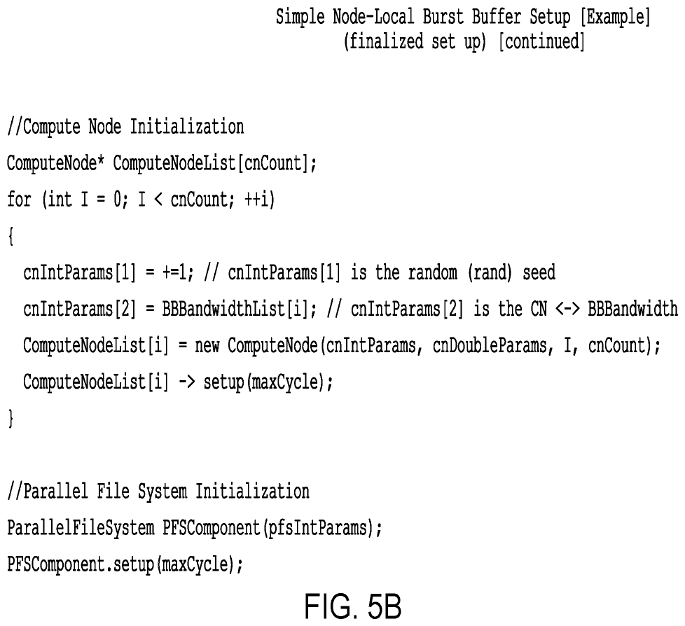

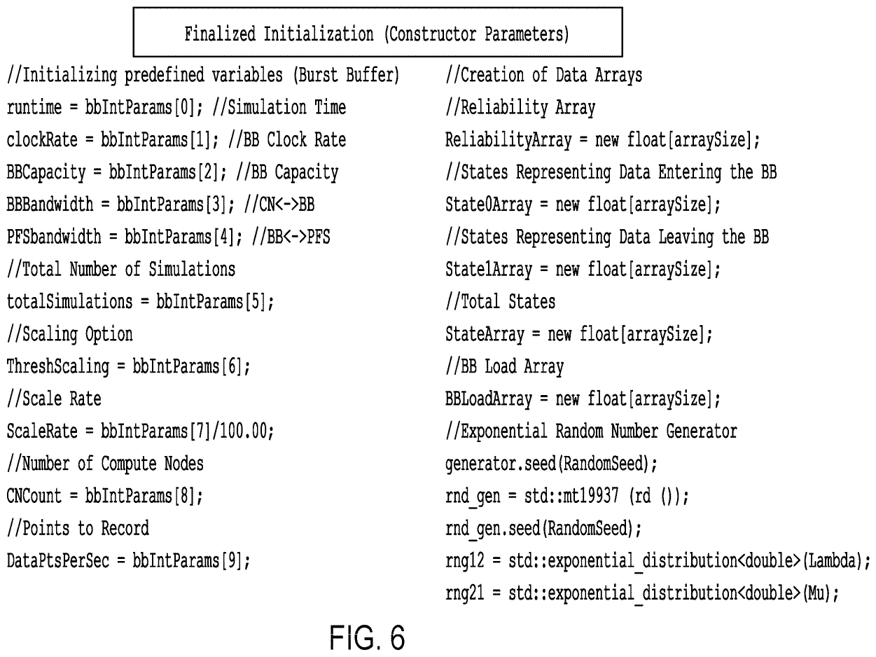

FIG. 5A and FIG. 5B show an example simple Burst Buffer Configuration [node-local] according to examples of the present disclosure, where components are created using overloaded constructors, where the previously defined parameters are placed into an array. Next, finalization is done via the setup function finalizing the additional required internal parameters for successful simulation. As shown in FIG. 5A and FIG. 5B, the Burst Buffer initialization is given by “BurstBuffer* BurstBufferList[cnCount]; BurstBufferList[0]=new BurstBuffer (bbIntParams, bbFloatParams, 0); BurstBufferList[0]->setup (maxCycle)” and “BurstBufferList[i]=new BurstBuffer (bbIntParams, bbFloatParams, 1); BurstBufferList[i]->setup (maxCycle), the Compute Node initialization is given by “ComputeNodeList[i]=new ComputeNode (cnIntParams, cnDoubleParams, I, cnCount); ComputeNodeList[i]->setup (maxCycle),” and PFS initialization is given by “ParallelFileSystem PFSComponent (pfsIntParams); PFSComponent.setup (maxCycle).”

FIG. 6 shows an example output BB initialization, CN initialization, and FPS initialization according to examples of the present disclosure. The output allows the finishing of the initialization where the following functions are used: constructor, which allows for all the predefined variables to be initialized with the given values and setup, which allows for the burst buffer to create and define any remaining data structures that do not need to be predefined. As shown in FIG. 6, the constructor is initialized with predefined variables and the creation of data arrays and the setup is initialized with additional variables and the creation of output files. Also as shown in FIG. 6, the constructor is initialized with exponential distribution random number generator and the initialization of predefined variables, and the setup is initialized with additional variables.

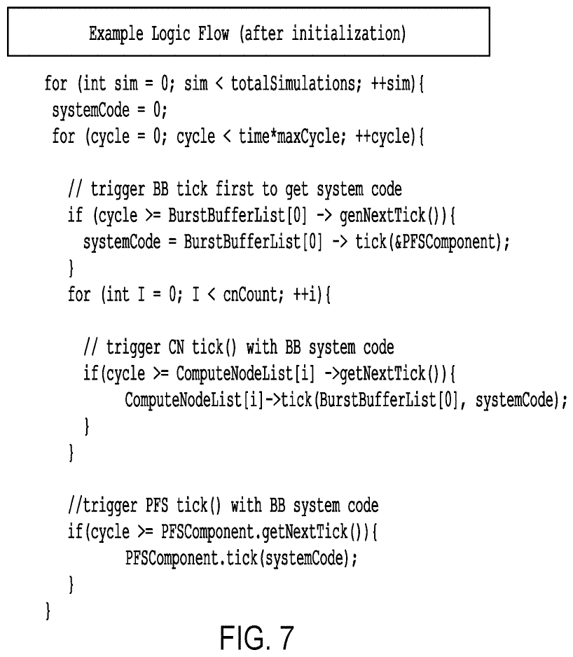

FIG. 7 shows an example Simple Burst Buffer Configuration for Node-Local Configuration Logic Flow according to examples of the present disclosure where once all components are initialized with their setup functions, the user then determines a logic flow to allow the components to work with one another. As shown in FIG. 7, the example logic flow contains portions that trigger BB tick first to get system code as shown as “if (cycle >=BurstBufferList[0]->genNextTick( ){systemCode=BurstBufferList[0]->tick (&PFSComponent),” portions that trigger CN tick ( ) with BB system code as shown as “if (cycle >=ComputeNodeList[i]->getNextTick ( )){ComputeNodeList[i]->tick (BurstBufferList[0], systemCode),” and trigger PFS tick ( ) with BB system code as shown as “if (cycle >=PFSComponent.getNextTick( )){PFSComponent.tick (systemCode).”

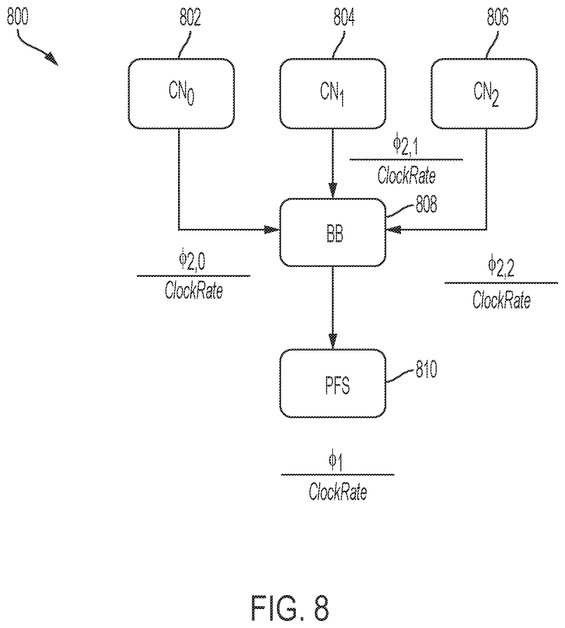

FIG. 8 shows an example of a simple Burst Buffer configuration for a remote shared configuration simulation setup according to examples of the present disclosure. In these remote-share configurations, some components include the following: multiple compute nodes (CNs), single burst buffer (BB), and single parallel file system (PFS). Each Compute Node is attached to its own private burst buffer where data flows from the CN to the BB and status codes (*) are supplied to CN from BB. All Burst Buffers are connected to a singular PFS where data flows from BB to PFS and status codes (*) are supplied to PFS from BB. Status codes (*) are responsible for informing components when to enact special commands such as pausing a component or resetting a component. As shown in FIG. 8 the example Simple Burst Buffer Configuration for Remote-Shared Configuration Simulation Setup 800 where data from each CN₀ 802, CN₁ 804, and CN₂ 806 flows to BB 808, which then flows to PFS 810.

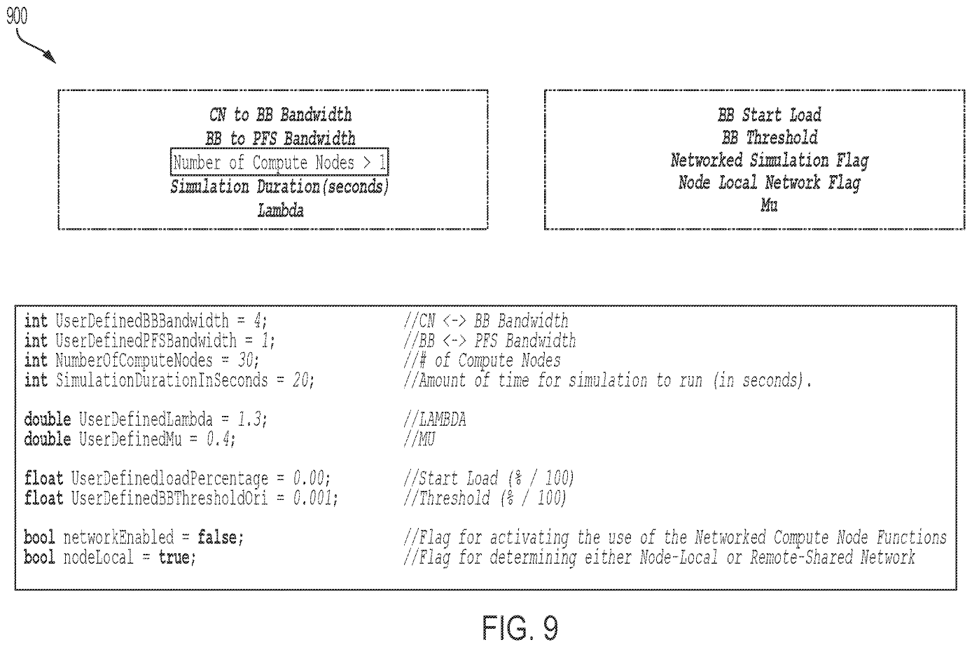

FIG. 9 shows an example Simple Burst Buffer Configuration for Remote-Shared Configuration Simulation Setup 900 according to examples of the present disclosure where all steps for creating a remote-shared configuration is the same with the exception of Number of Compute Nodes variable being greater than 1.

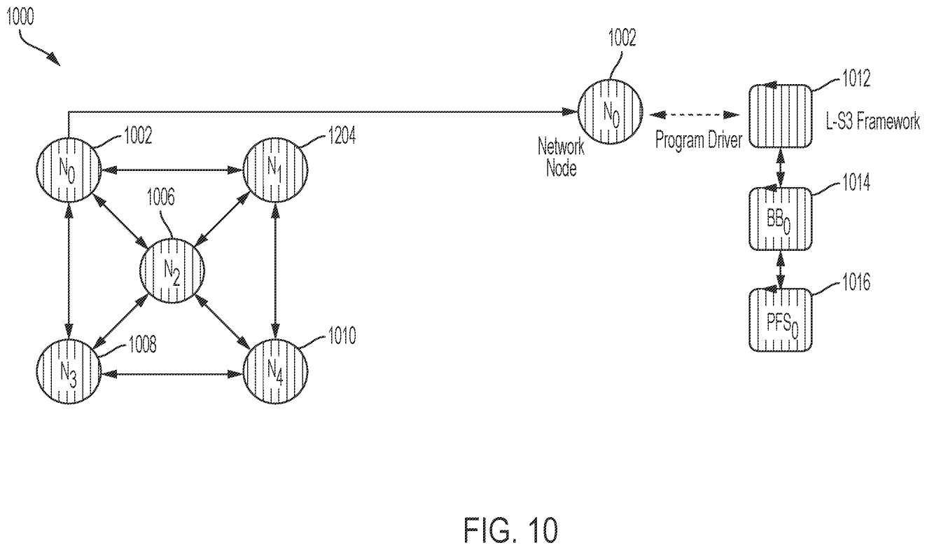

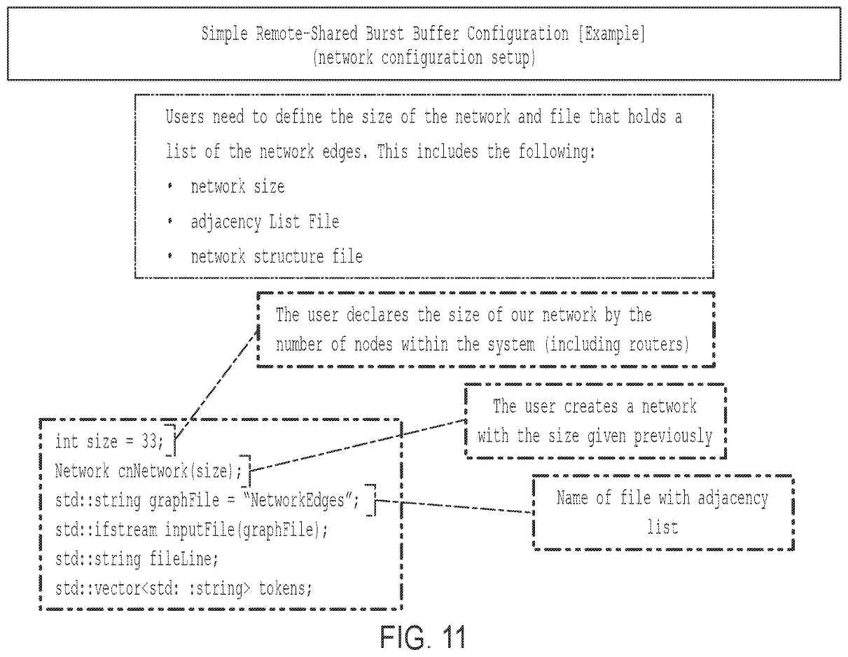

FIG. 10 shows an example network configuration 1000 according to examples of the present disclosure. The configurable network allows for users to define how they wish to interlink compute nodes with one another, which allows the user to simulate various HPC architectures. Each node within the network can be connected to a compute node to create multiple node-local burst buffers. Each burst buffer within the system then feeds its data to a central parallel file system. As shown in FIG. 10, network nodes N₀ 1002, N₁ 1004, N₂ 1006, N₃ 1008, and N₄ 1010 are connected to L-S3 framework CN₀ 1012. L-S3 framework CN₀ 1012 is connected to BB₀ 1014, which is then connected to PFS₀ 1016.

FIG. 11 shows an example simple Burst Buffer configuration for a network configuration setup according to examples of the present disclosure. As shown in FIG. 11, the example simple Burst Buffer configuration for a network configuration setup shows where the user defines the size of the network and the file that holds a list of network edges. The size of the network is defined by specifying the number of nodes within the system including routers. The user then creates a network with the size previously provided. The name of the file with adjacency list is also shown.

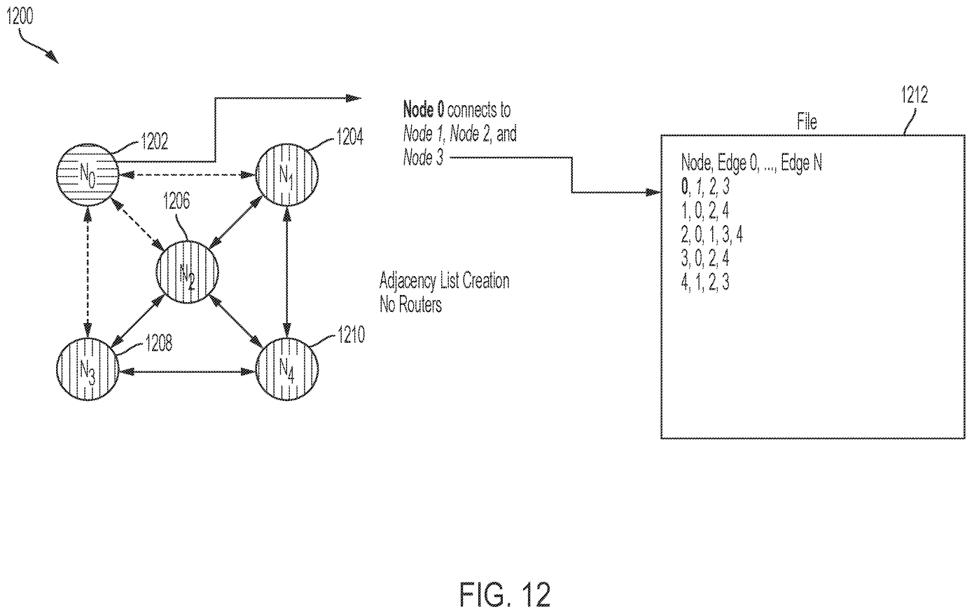

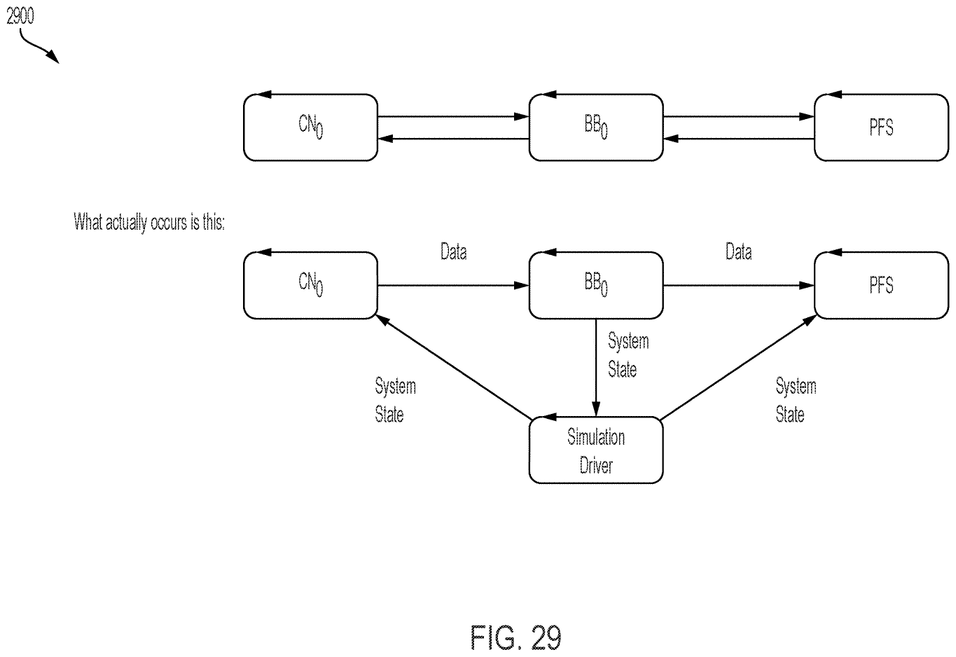

FIG. 12 shows an example simple Burst Buffer configuration for a network configuration setup 1200 according to examples of the present disclosure where the network uses adjacency lists in order to create a user defined network. In order to create one of these adjacency lists the following steps can be followed. Depending on whether the network that the user wishes to represent has routers, the steps may vary slightly. The first example shown in FIG. 29 is with no routers. Node 0 (N0) 1202 connects to Node 1 (N₁) 1204, Node 2 (N₂) 1206, and Node 3 (N₃) 1208. Node 4 (N₄) 1210 is not connected to Node 0 (N₀) 1202. File 1212 lists Node, Edge 0, . . . , Edge N as follows: 0, 1, 2, 3; 1, 0, 2, 4; 2, 0, 1, 3, 4; 3, 0, 2, 4; and 4, 1, 2, 3.

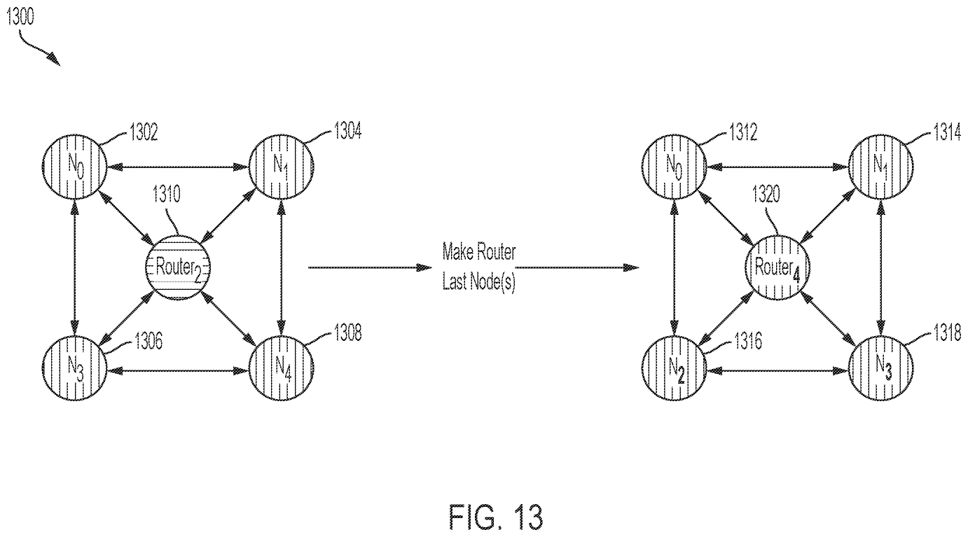

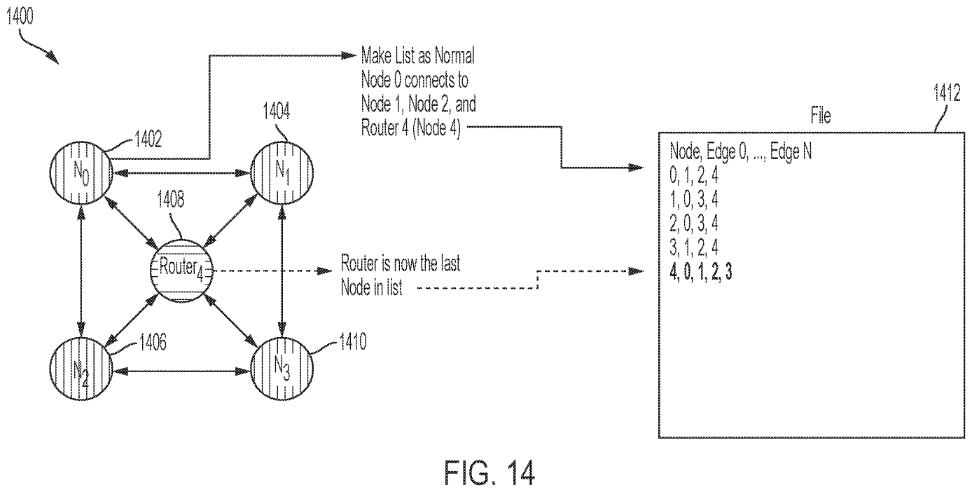

FIG. 13 shows an example simple Burst Buffer configuration for a network configuration setup 1300 according to examples of the present disclosure where the network uses adjacency lists in order to create a user defined network. In the case of routers, the numbering of the network is first adjusted in order to place the routers at the end of the adjacency list file. As shown at left in FIG. 13, Node 0 (N₀) 1302 is connected to Node 1 (N₁) 1304, Node 3 (N₃) 1306, and Router (Node 2) 1310. Node 1 (N₁) 1304 is connected to Node 0 (N₀) 1302, Node 4 (N₄) 1308, and Router (Node 2) 1310. Node 3 (N₃) 1306 is connected to Node 0 (N₀) 1302, Node 4 (N₄) 1308, and Router (Node 2) 1310. Node 4 (N₄) 1308 is connected to Node 1 (N₁) 1304, Node 3 (N₃) 1306, and Router (Node 2) 1310. Router (Node 2) 1310 is connected to Node 0 (N₀) 1302, Node 1 (N₁) 1304, Node 3 (N₃) 1306, and Node 4 (N₄) 1308. At right in FIG. 13, the network is shown after Router (Node 2) 1310 is made the last node(s) in the network, namely from adjusted from Node 2 to Node 4. Therefore, the adjusted network is as follows. Node 0 (N₀) 1312 is connected to Node 1 (N₁) 1314, Node 2 (N₂) 1316, and Router (Node 4) 1320. Node 1 (N₁) 1314 is connected to Node 0 (N₀) 1312, Node 3 (N₃) 1318, and Router (Node 4) 1320. Node 2 (N₂) 1316 is connected to Node 0 (NO) 1312, Node 3 (N₃) 1318, and Router (Node 4) 1320. Node 3 (N₃) 1318 is connected to Node 1 (N₁) 1314, Node 2 (N₂) 1316, and Router (Node 4) 1320. Router (Node 4) 1320 is connected to Node 0 (N₀) 1312, Node 1 (N₁) 1314, Node 2 (N₂) 1316, and Node 3 (N₃) 1318.

FIG. 14 shows an example simple Burst Buffer configuration for a network configuration setup 1400 according to examples of the present disclosure where the original process is followed for converting the nodes and their edges to an adjacency list. In order to create one of these adjacency lists the following steps can be followed. Depending on whether the network that the user wishes to represent has routers, the steps may vary slightly. The second example shown in FIG. 14 is with one router. Node 0 (N₀) 1402 connects to Node 1 (N₁) 1404, Node 2 (N₂) 1406, and Router 4 (Node 4) 1408. Router 4 (Node 4) 1408 is now the last Node in the list. Node 3 (N₃) 1410 is not connected to Node 0 (N₀) 1402. File 1412 lists Node, Edge 0, . . . , Edge N as follows: 0, 1, 2, 4; 1, 0, 3, 4; 2, 0, 3, 4; 3, 1, 2, 4; and 4, 0, 1, 2, 3.

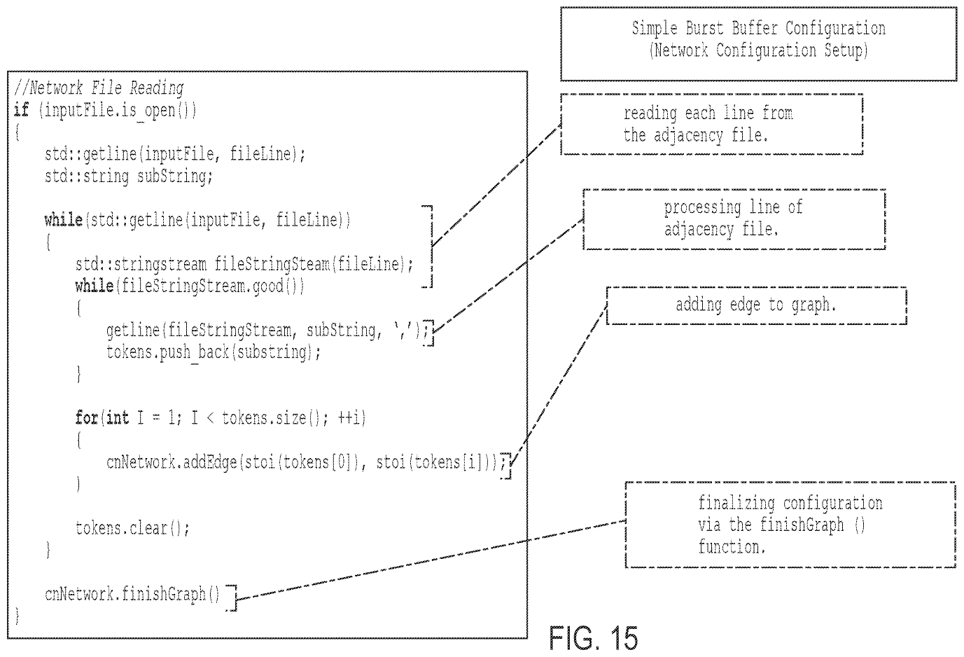

FIG. 15 shows an example of a simple Burst Buffer Configuration for a network configuration setup according to examples of the present disclosure where after variable definition, the adjacency list file is processed and the network is created, a second function, finishGraph ( ), is then used to finalize the configuration of the graph.

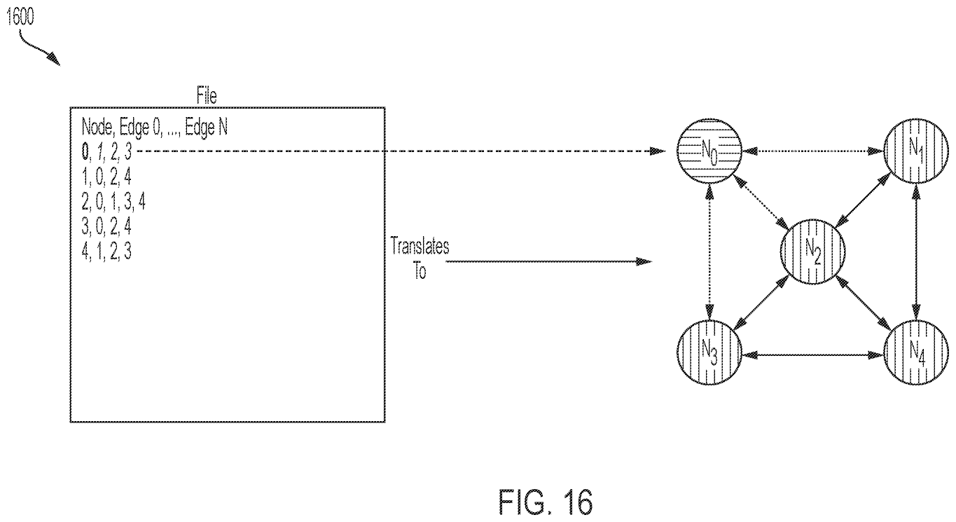

FIG. 16 shows an example of a simple Burst Buffer configuration 1600 for a reading adjacency list file according to examples of the present disclosure. The adjacency list is read and processed line by line. The file as shown at the left translates to the graph shown at the right.

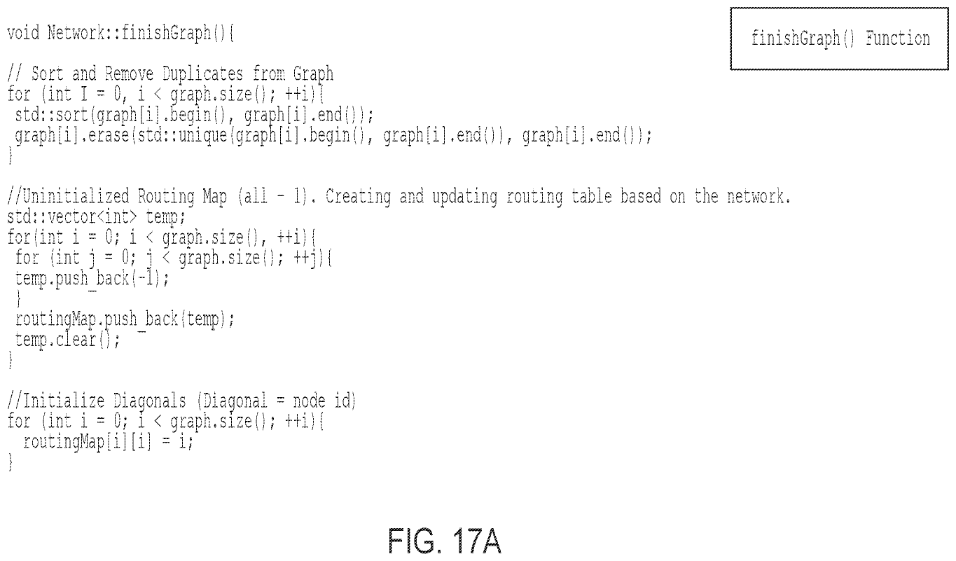

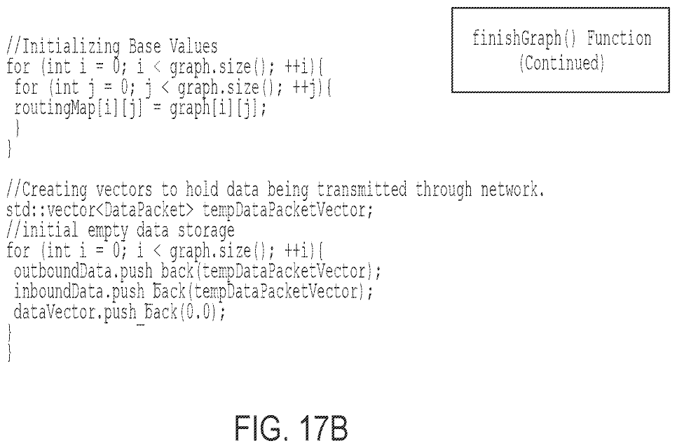

FIG. 17A and FIG. 17B show an example of a simple Burst Buffer configuration for a network finishGraph( ) function according to examples of the present disclosure. The finish Graph ( ) function called during finalizes the initialization of the graph by conducting the following actions: clean the edge list by removing duplicates creates the initial routing table for the network and creates empty vectors for storing packets during routing.

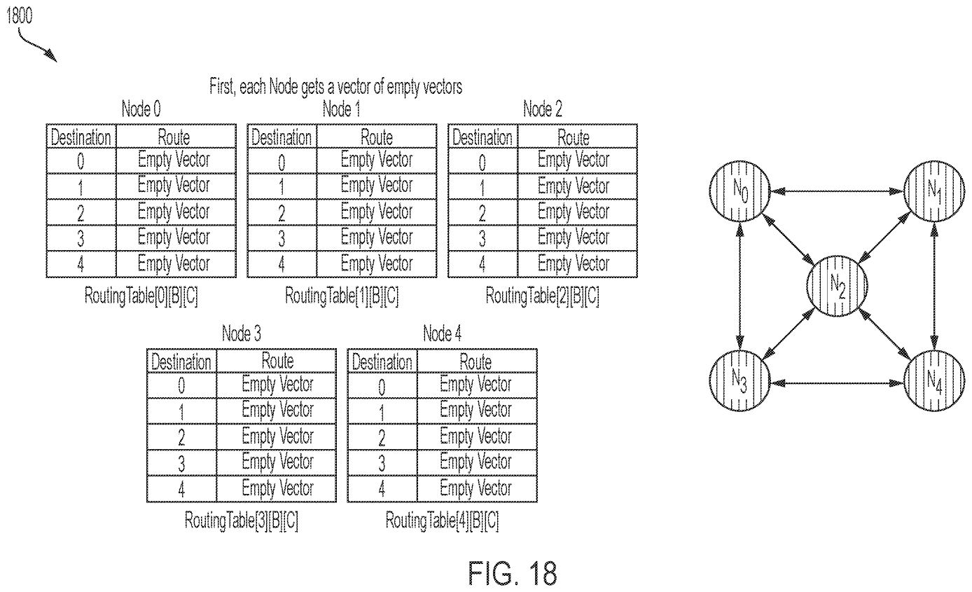

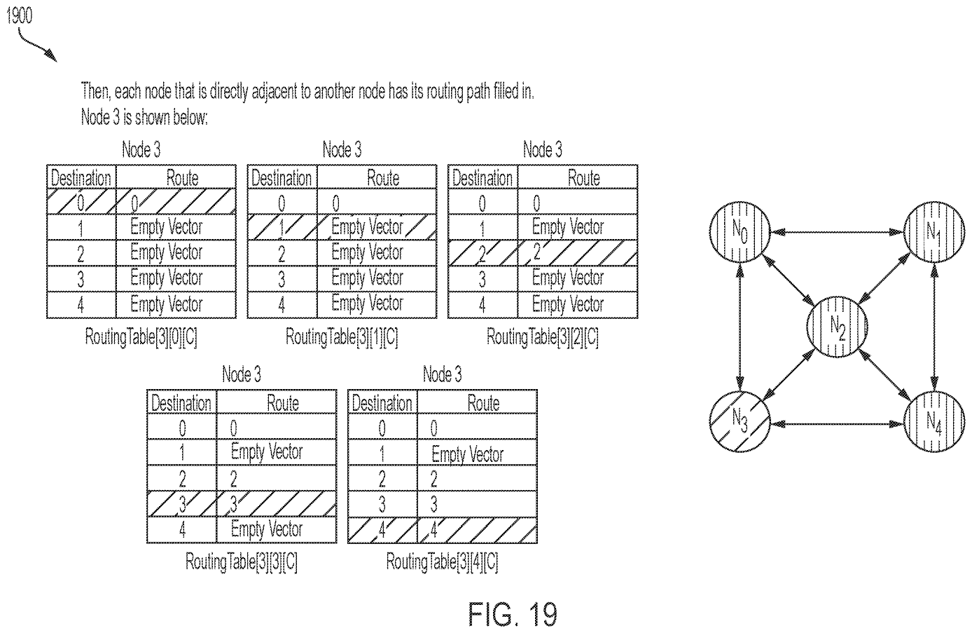

FIGS. 18 and 19 shows an example of a simple Burst Buffer configuration 1800 and 1900, respectively, for a network routing table according to examples of the present disclosure. The network uses a three-dimensional vector for determining where to route packets. The network starts with a default routing table created using the following steps. First, each Node give a vector of empty vectors. Then, each Node that is directly adjacent to another node has its routing path filled in. Node 3 is shown in FIG. 19. Because Node 3 and Node 1 are not directly connected, the route for destination 1 remains empty.

In the event a packet needs to be transmitted to a destination whose route is not yet known, those with an empty vector within the routing table, a route is found using Dijkstras' Algorithm. The results from this algorithm is then used to update the routing table. Table 3, as shown below, shows the routing table that has an empty vector, shown in shaded region, for route, time to use Dijkstra's algorithm.

TABLE 3
Routing Packet from Node 3 to Node 1

| Destination | Route |
|---|---|
| 0 | 0 |
| 1 | Empty Vector |
| 2 | 2 |
| 3 | 3 |
| 4 | 4 |

RoutingTable[3][1][C]

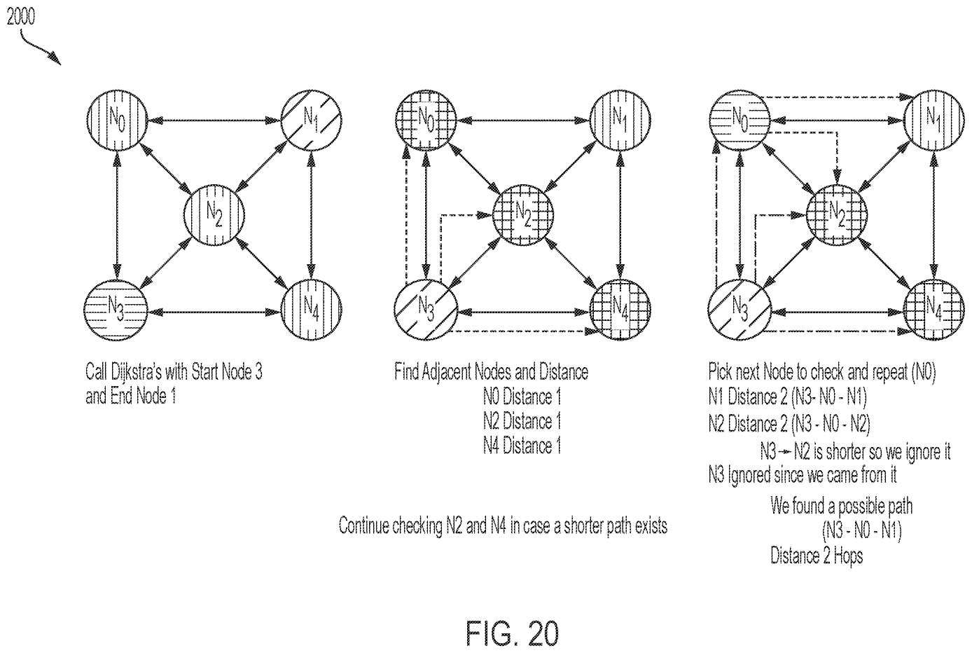

FIG. 20 shows an example of a simple Burst Buffer configuration 2000 for a network Dijkstra's steps 1-3 according to examples of the present disclosure. In steps 1-3, Dijkstra's algorithm is used with a Start Node 3 and End Node 1 so that a path can be found that goes from Node 3 to Node 1. In step 1, Dijkstra's algorithm is used with a Start Node 3 and End Node 1. In step 2, adjacent nodes and distances are found, where the distances are N0 Distance 1, N2 Distance 2, and N4 Distance 1. N2 and N4 are continued to be checked in case a shorter path exists. In step 3, the next Node is chosen to check and (N0) where N1 Distance 2 (N3-N0-N1), N2 Distance 2 (N3-N0-N2), N3>N2 is shorter so N3 is ignored since that is where it came from.

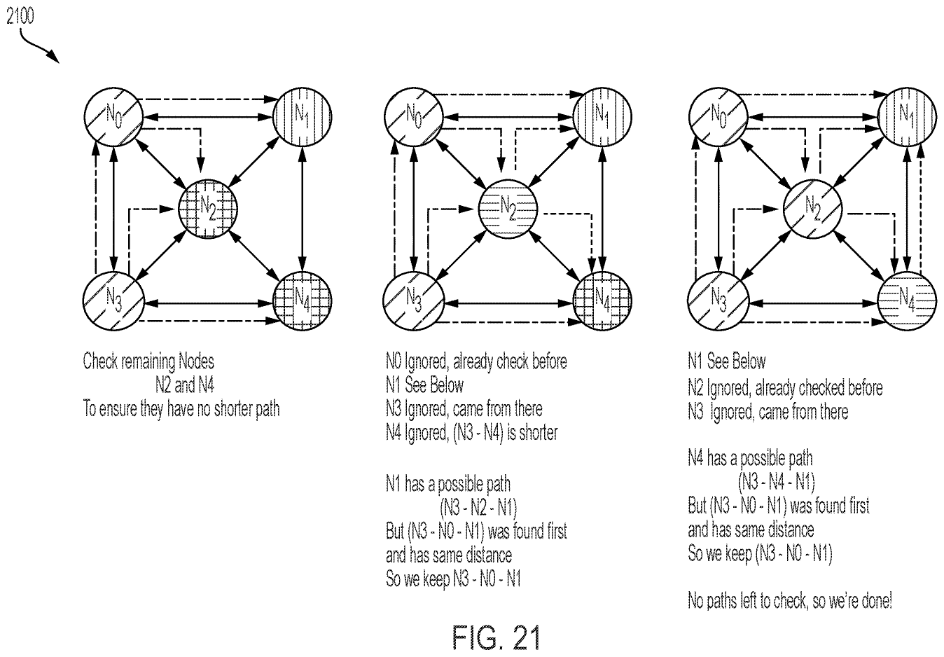

FIG. 21 shows an example of a simple Burst Buffer configuration 2100 for a network Dijkstra's steps 4-6 according to examples of the present disclosure. In step 4, the remaining nodes (N2 and N4) are checked to ensure they have no shorter path. In step 5, N0 is ignored since it is already checked, N3 is ignored since it came from there, N4 is ignored since N3-N4 is shorter, and N1 has a possible path (N3-N2-N1) but N3-N0-N1 was found first and has the same distance. So, the path N3-N0-N1 is kept. In step 6, N2 is ignored since it is already checked, N3 is ignored since it came from there, N4 has a possible path (N3-N4-N1) but (N3-N0-N1) was found first and has the same distance. So, the path N3-N0-N1 is kept. After this, no other paths are left do check, so the process ends.

Table 4 shows an example routing table showing the resulting path from Dijkstra's algorithm of a simple Burst Buffer configuration for a network updating routing table according to examples of the present disclosure. The resulting path from Dijkstra's, as shown in the shaded section of the below table, is used to update the below routing table to reduce the need for conducing searches in the future. With an updated routing table, all future packet transfers from Node 3 to Node 1 can use the previously found route. Now, if N₂ wants to communicate with N₁. Routing Table[3][1] [C] gives the vector of the route to take. In order to use this list, C is used to index the current hop the packet is on. In this case, hop 1 is index 0 due to 0 based indexing.

TABLE 4
Node 3

| Destination | Route |
|---|---|
| 0 | 0 |
| 1 | 0 1 |
| 2 | 2 |
| 3 | 3 |
| 4 | 4 |

RoutingTable[3][1][C]

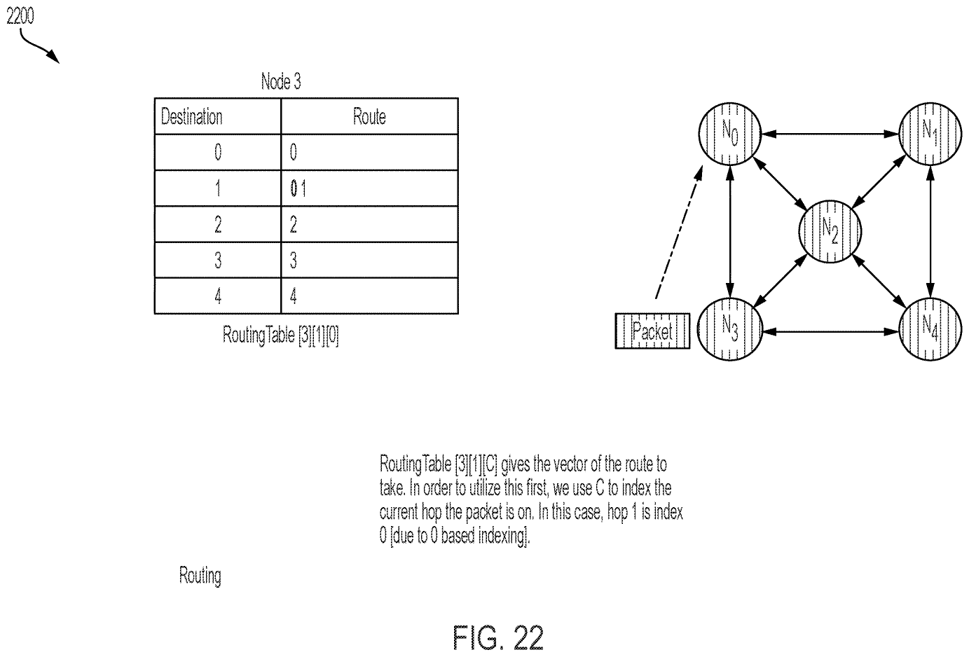

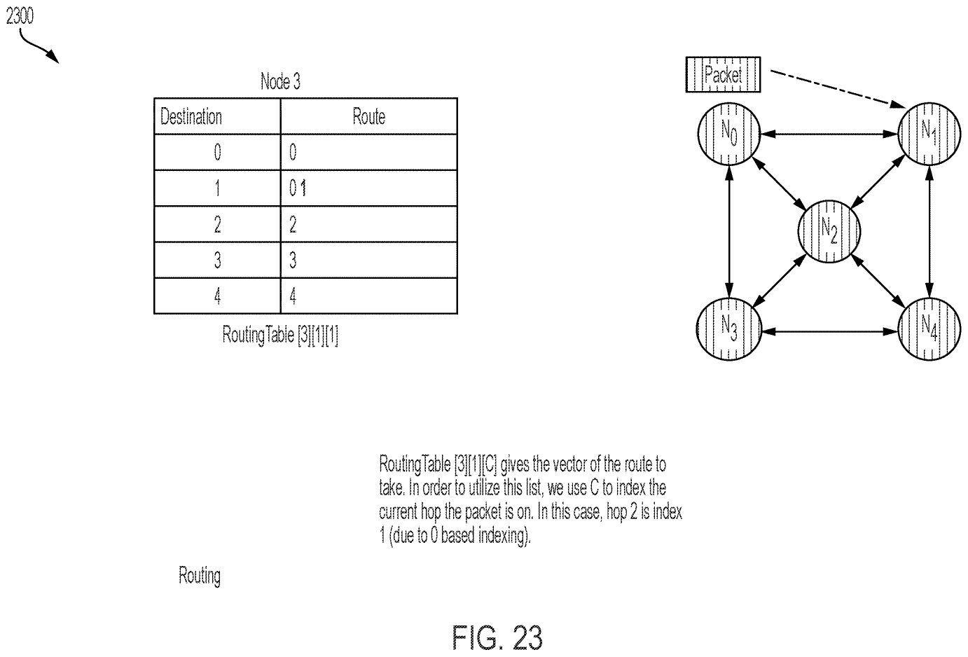

FIG. 22 shows an example of a simple Burst Buffer configuration 2200 for a network updating routing table according to examples of the present disclosure. For the first hop, the packet will refer to RoutingTable[3] [1] [0] from Table 4, that is from Node 3, to Node 1, Hop 0. RoutingTable[3] [1] [C] gives the vector of the route to take. In order to use this list, C is used to index the current hop the packet is on. In this case, hop 1 is index 0 (due to 0 based indexing). Table 5 below is for Node 3 as shown in FIG. 23.

TABLE 5
Node 3

| Destination | Route |
|---|---|
| 0 | 0 |
| 1 | 0 1 |
| 2 | 2 |
| 3 | 3 |
| 4 | 4 |

RoutingTable[3][1][0]

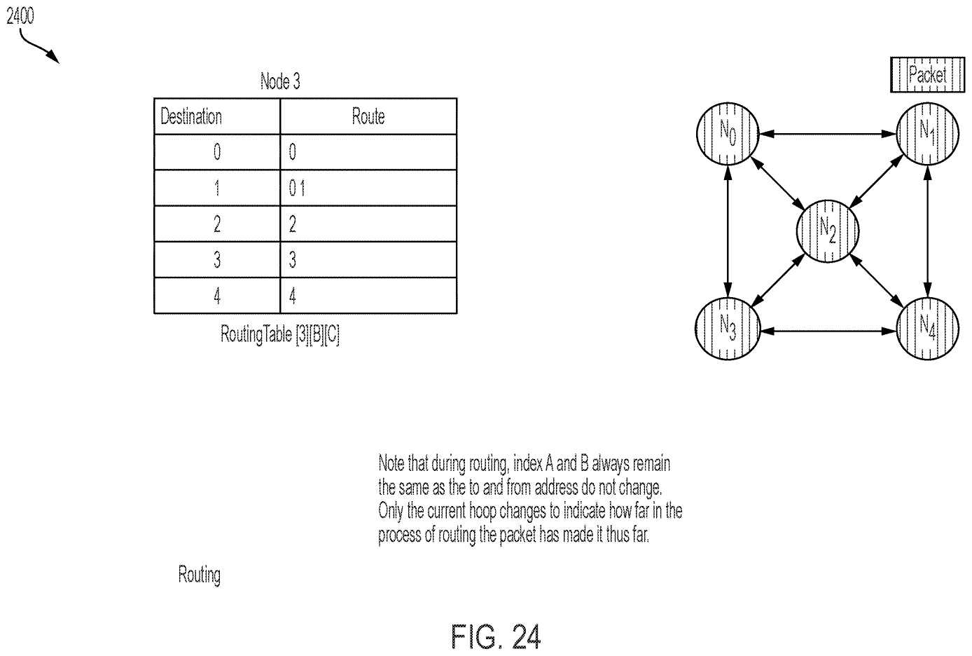

FIG. 23 shows an example of a simple Burst Buffer configuration 2300 for a network updating routing table according to examples of the present disclosure. For the second hop, the packet will refer to RoutingTable[3] [1] [1], That is from Node 3, to Node 1, Hop 1. RoutingTable[3] [1] [C] gives the vector of the route to take. In order to use this list, C is used to index the current hop the packet is on. In this case, hop 2 is index 1 (due to 0 based indexing). Table 6 below is for Node 3 as shown in FIG. 24.

TABLE 6
Node 3

| Destination | Route |
|---|---|
| 0 | 0 |
| 1 | 0 1 |
| 2 | 2 |
| 3 | 3 |
| 4 | 4 |

RoutingTable[3][1][1]

FIG. 24 shows an example of a simple Burst Buffer configuration 2400 for a network updating routing table according to examples of the present disclosure. The packet has arrived at its destination. Thus, routing of the packet is now complete. Note that during routing, index A and B always remain the same as the to and from address do not change. Only the current hop changes to indicate how far in the process of routing the packet has made it thus far. Table 7 below is for Node 3 as shown in FIG. 24.

TABLE 7
Node 3

| Destination | Route |
|---|---|
| 0 | 0 |
| 1 | 0 1 |
| 2 | 2 |
| 3 | 3 |
| 4 | 4 |

RoutingTable[3][B][C]

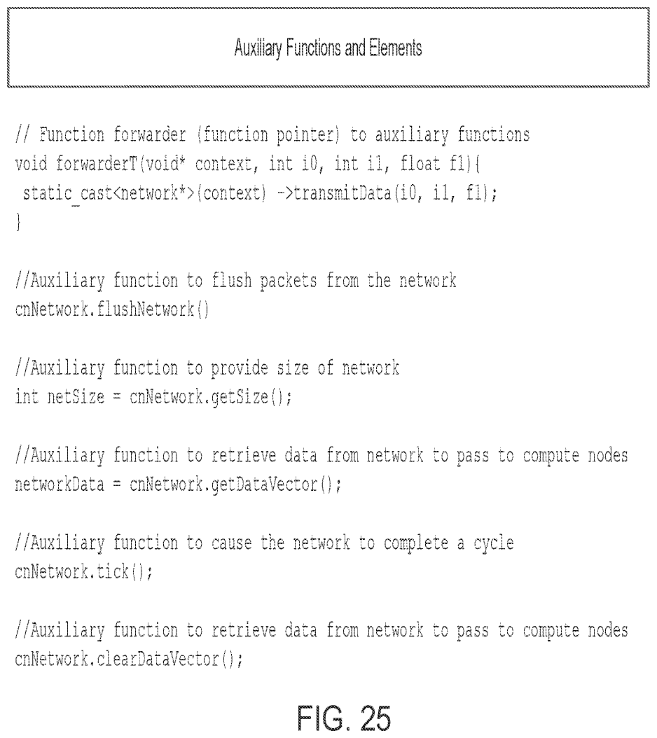

FIG. 25 shows an example function pointer and network function for a simple Burst Buffer configuration for a network to L-S3 framework connection according to examples of the present disclosure. With the network now established, one remaining task is to create a function pointer and connect auxiliary functions to the driver facilitating communication between the network and the L-S3 Framework. Examples of the function pointer and network function are shown in FIG. 25.

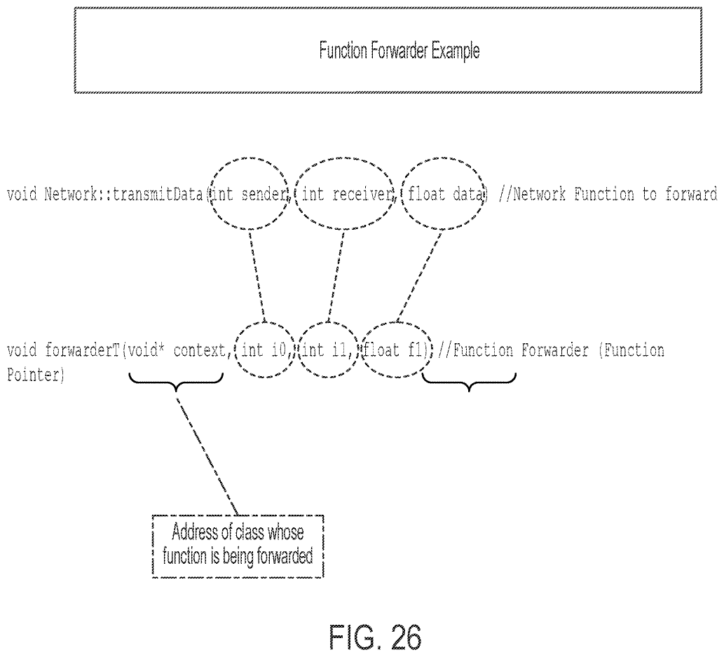

FIG. 25 shows an example function pointer and network function for a simple Burst Buffer configuration for a network to L-S3 framework connection according to examples of the present disclosure. Auxiliary functions help provide the functionality needed to run the simulation, obtain data, and then reset the network for additional simulation passes. FIG. 26 shows an example function forwarder according to examples of the present disclosure.

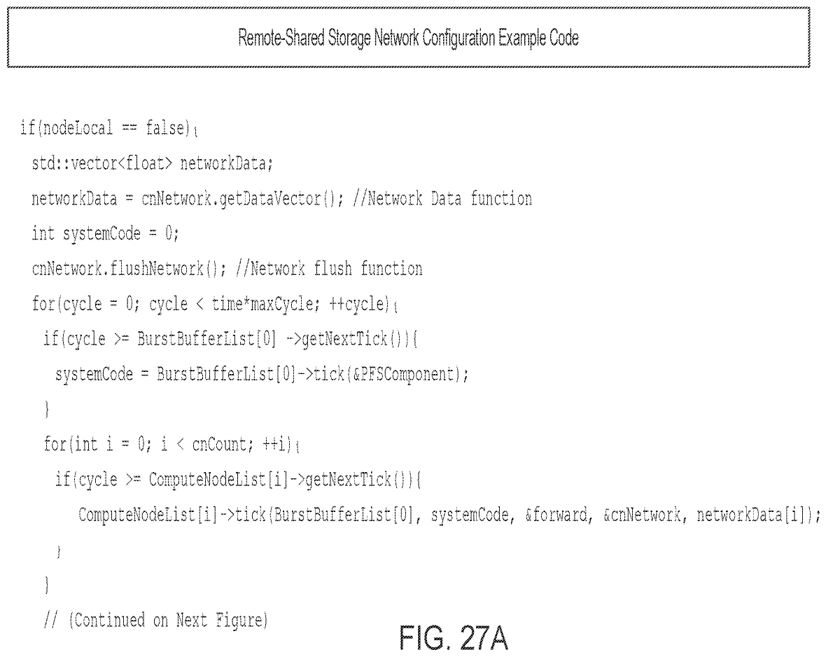

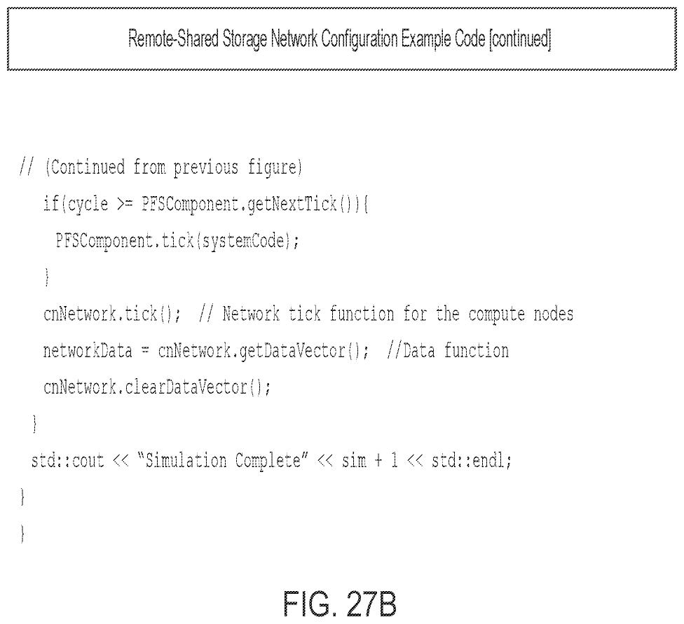

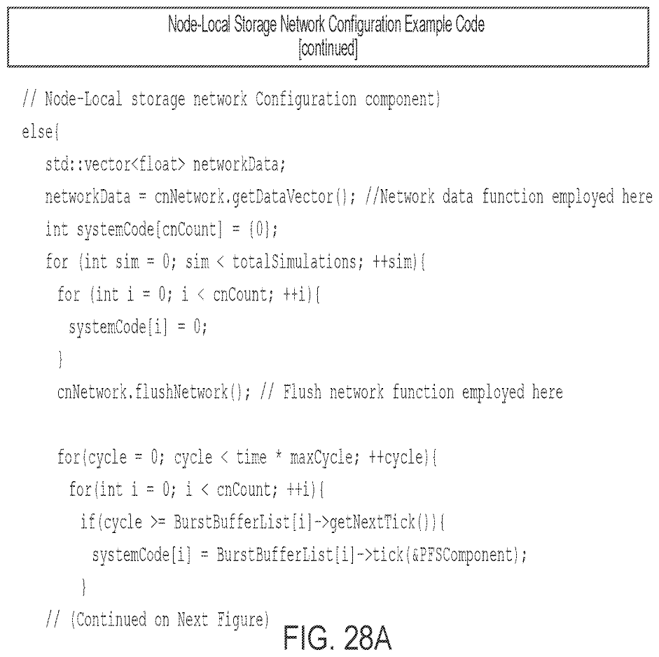

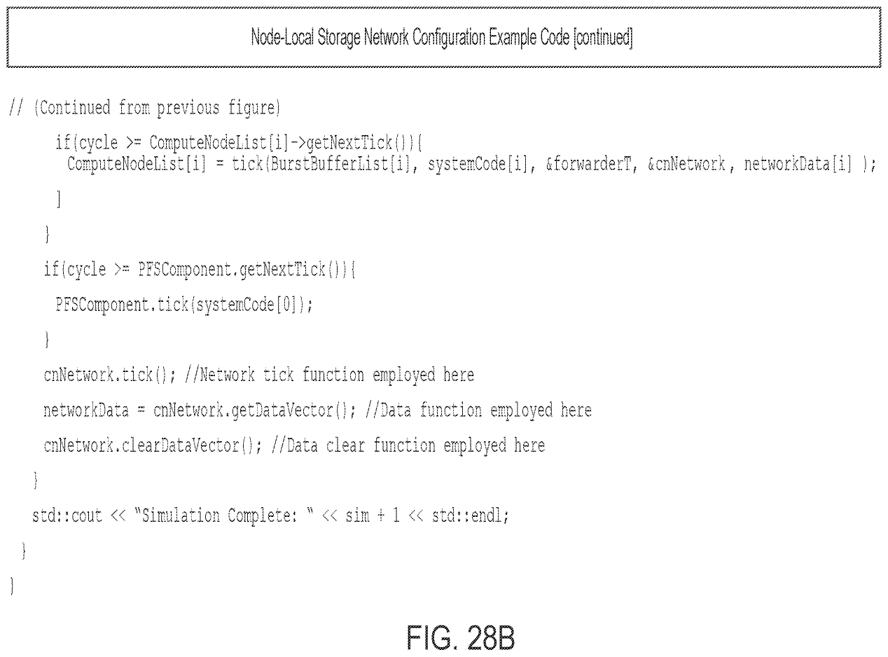

FIG. 27A and FIG. 27B and FIG. 28A and FIG. 28B show an example of a simple Burst Buffer configuration for a network to L-S3 framework connection according to examples of the present disclosure. Once connected, these functions allow for running the LS-3 Framework on a remote-shared environment as shown in FIG. 27A and FIG. 27B or in a node-local environment as shown in FIG. 28A and FIG. 28B.

FIG. 29 shows an example of a simple Burst Buffer configuration 2900 for a network to L-S3 framework connection according to examples of the present disclosure. After initializing the L-S3 Framework, a node-local and remote-shared simulation can be run. The communication that occurs during runtime using a high-level configuration where CN₀ communicates with BB₀, which then communicates with PFS in one direction and PFS communicates with BB₀, which then communicates with CN₀ in a second direction. In actuality during simulation, CN₀ communicates by providing data to BB₀ and CN₀ communicates by providing system data to simulation. BB₀ communicates by providing system data to simulation driver and communicates by providing data to PFS. Simulation driver communicates by providing system data to PFS.

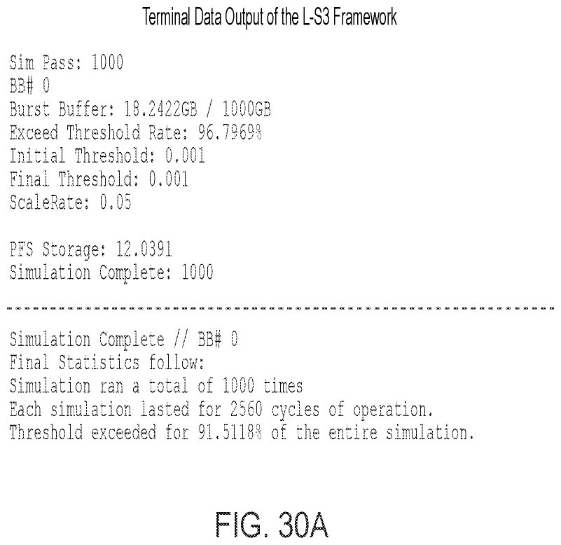

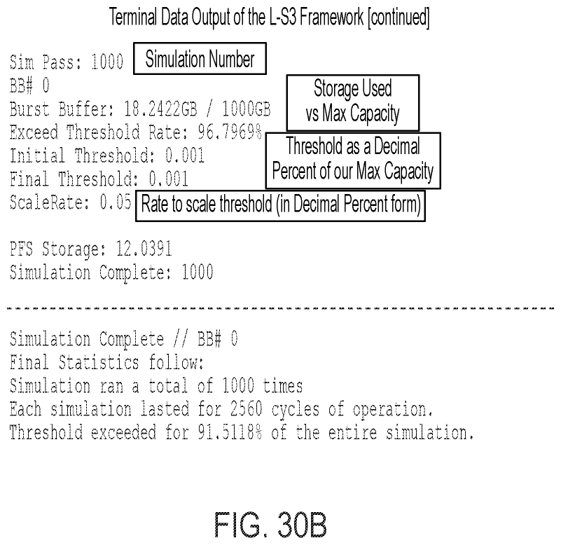

FIG. 30A and FIG. 30B show an example of data output for L-S3 framework data output according to examples of the present disclosure. In particular, FIG. 30A and FIG. 30B show data output L-S3 Framework data output where the L-S3 framework has two output forms where the first output is information transmitted directly to the user via the terminal and the second output are data files created for users to use as needed.

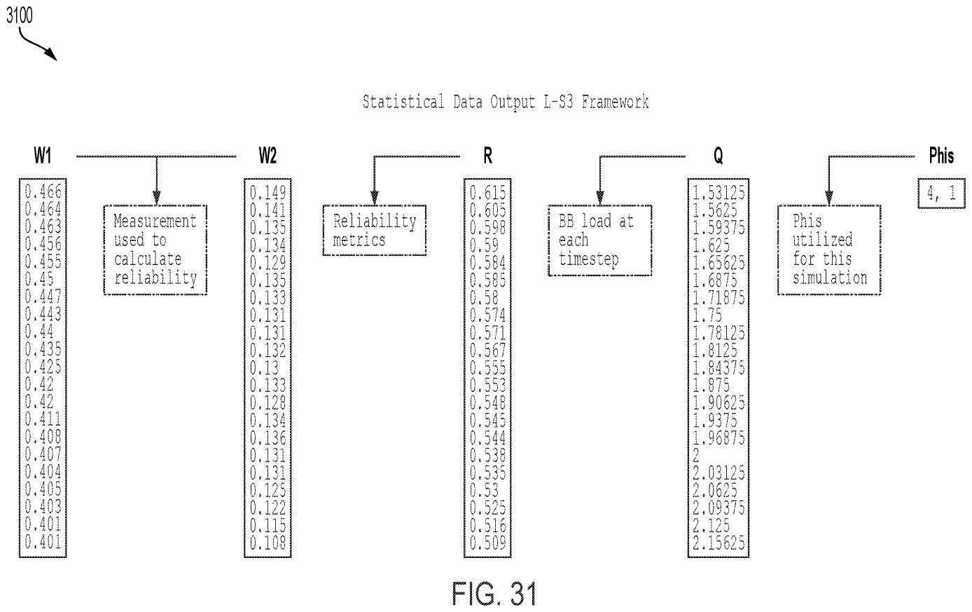

FIG. 31 shows example data output files where the L-S3 Framework 3100 has two output forms where the first output is information transmitted directly to the user via the terminal and the second are data files created for users to use as needed.

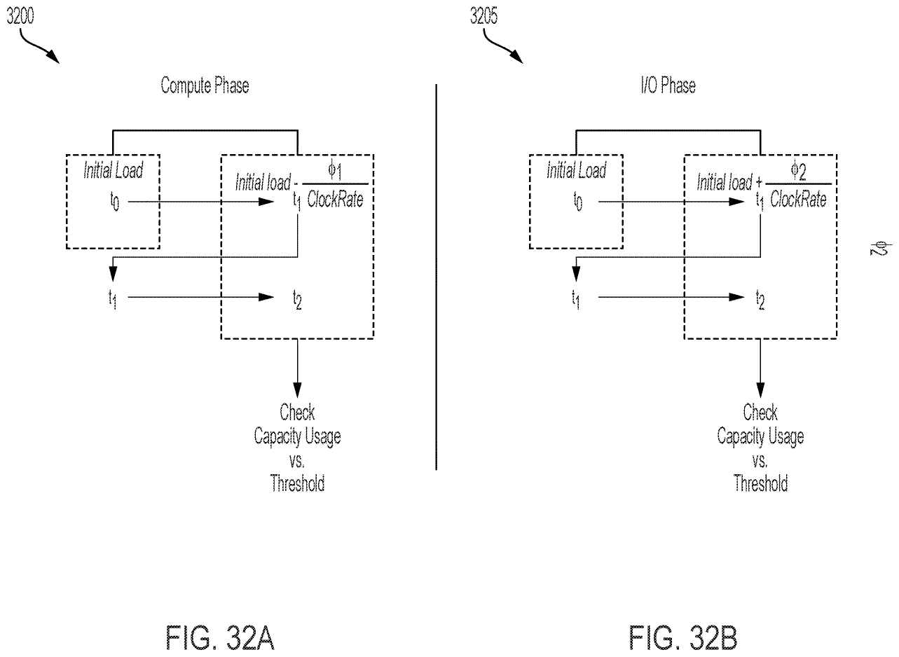

FIG. 32A and FIG. 32B show an example of a functionality: threshold checking according to examples of the present disclosure, where FIG. 32A shows a compute phase 3200 and FIG. 32B shows a I/O phase 3205. Throughout the simulation, the used capacity of the burst buffer is constantly checked at each time step. The results of this check are then used to update the data arrays and record statics for future use.

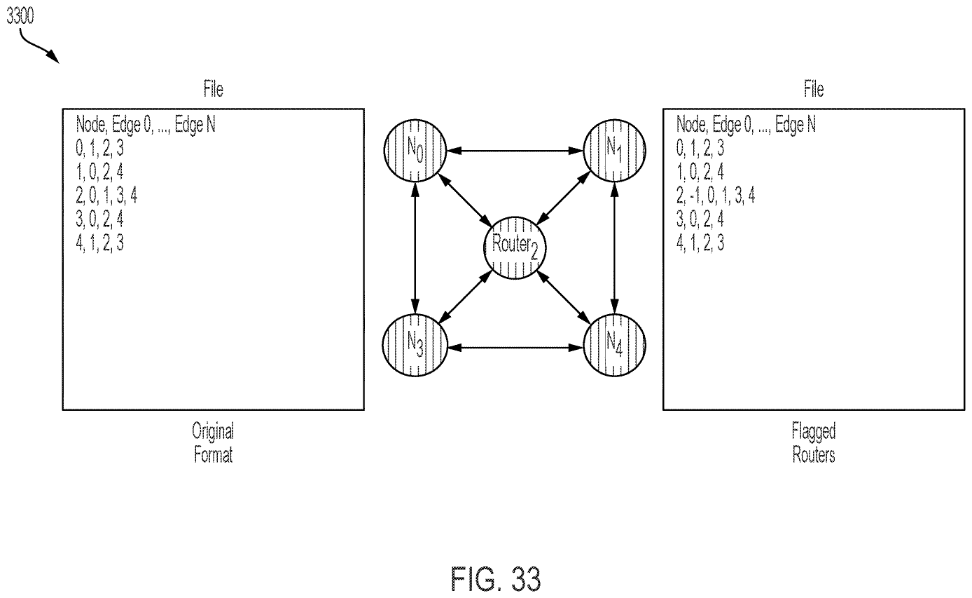

FIG. 33 shows an example of a data output 3300: flagging routers approach according to examples of the present disclosure. The flagging routers allows the user to retain the numbering of their network allowing for the most ease in readability. The current back loaded method was chosen for its simplicity but as the network continues to be developed, more strides are being taken to improve its efficiency. The process is outlined in the following manner. The File in original format of Node, Edge 0, . . . , Edge N includes the following: 0, 1, 2, 3; 1, 0, 2, 4; 2, 0, 1, 3, 4; 3, 0, 2, 4; and 4, 1, 2, 3. The File formatted by front-loading the routers in the format of Node, Edge 0, . . . , Edge N includes the following: 0, 1, 2, 3; 1, 0, 2, 4; 2, −1, 0, 1, 3, 4; 3, 0, 2, 4; and 4, 1, 2, 3.

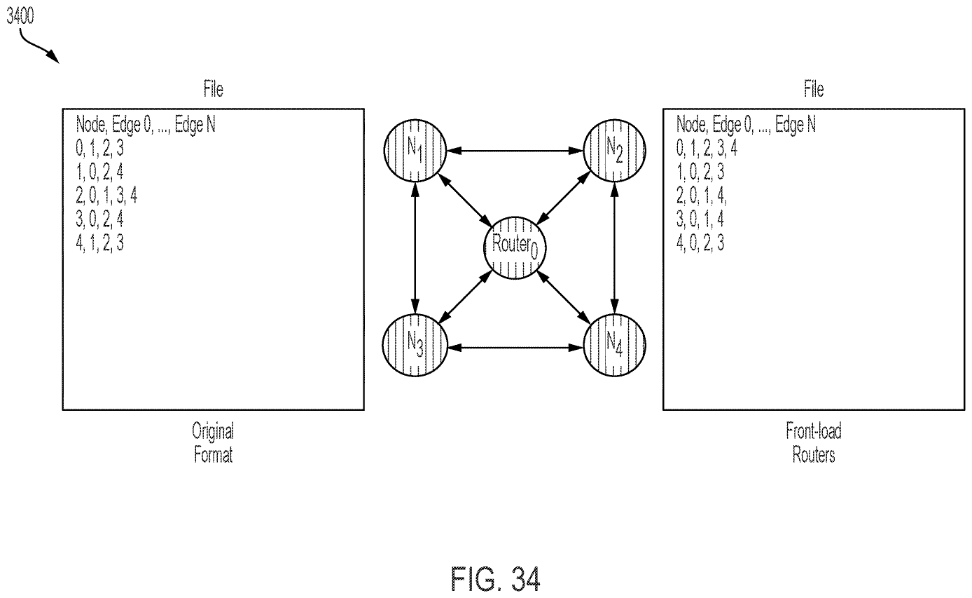

FIG. 34 shows an example of a data output for a front-load routers method 3400 according to examples of the present disclosure. In this format, the routers were front loaded to identify them early on during runtime. The process makes it easier to attach the compute nodes to various network formulations. The process is outlined in the following manner. The File in original format of Node, Edge 0, . . . , Edge N includes the following: 0, 1, 2, 3; 1, 0, 2, 4; 2, 0, 1, 3, 4; 3, 0, 2, 4; and 4, 1, 2, 3. The File formatted by front-loading the routers in the format of Node, Edge 0, . . . , Edge N includes the following: 0, 1, 2, 3, 4; 1, 0, 2, 3; 2, 0, 1, 4; 3, 0, 1, 4; and 4, 0, 2, 3.

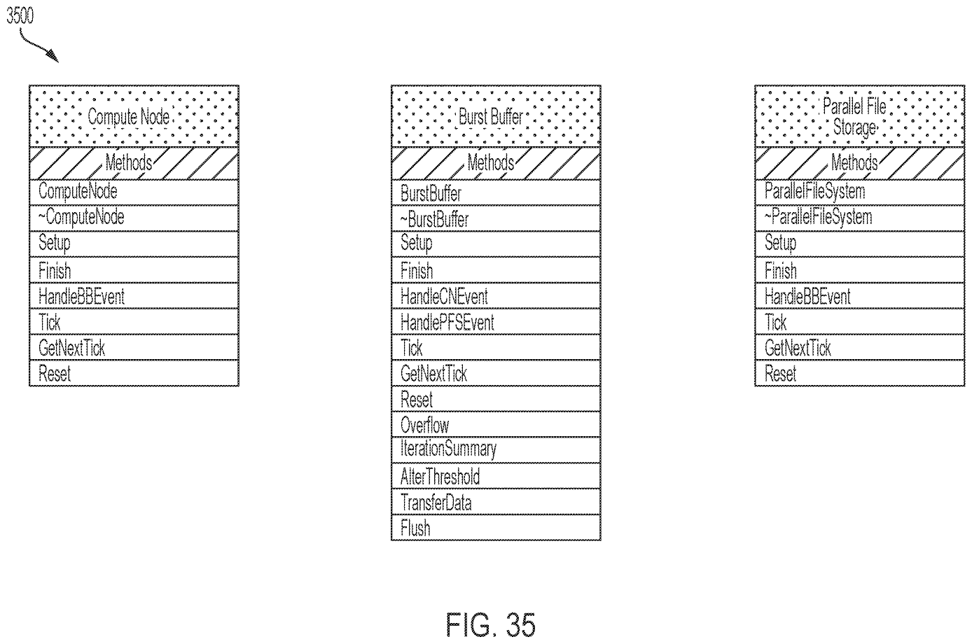

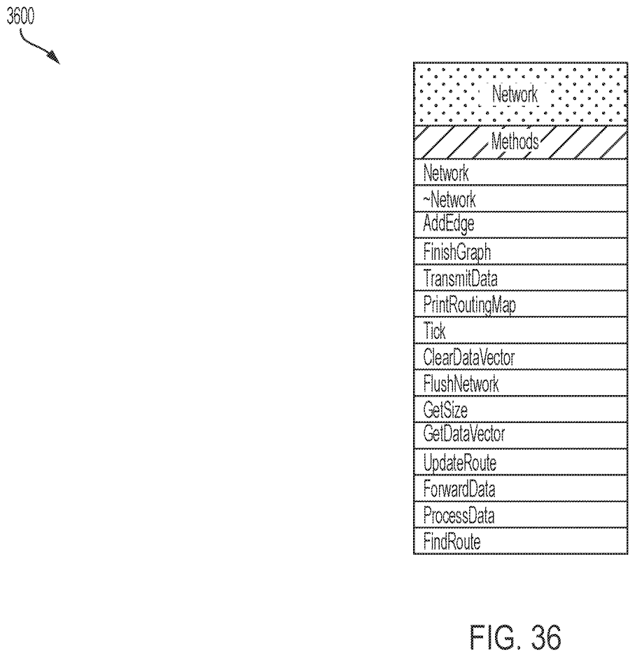

FIG. 35 shows an example of component functionality features 3500 according to examples of the present disclosure. Each component of the L-S3 Framework uses various methods in order to provide functionality to the simulation. FIG. 36 shows an example of network functionality features 3600 according to examples of the present disclosure. As shown in FIG. 35 and FIG. 36, a class breakdown of all the methods used by the Network class is shown in order to complete its functionality. Each of these functions are shown in the class diagrams provided in FIG. 35 and FIG. 36.

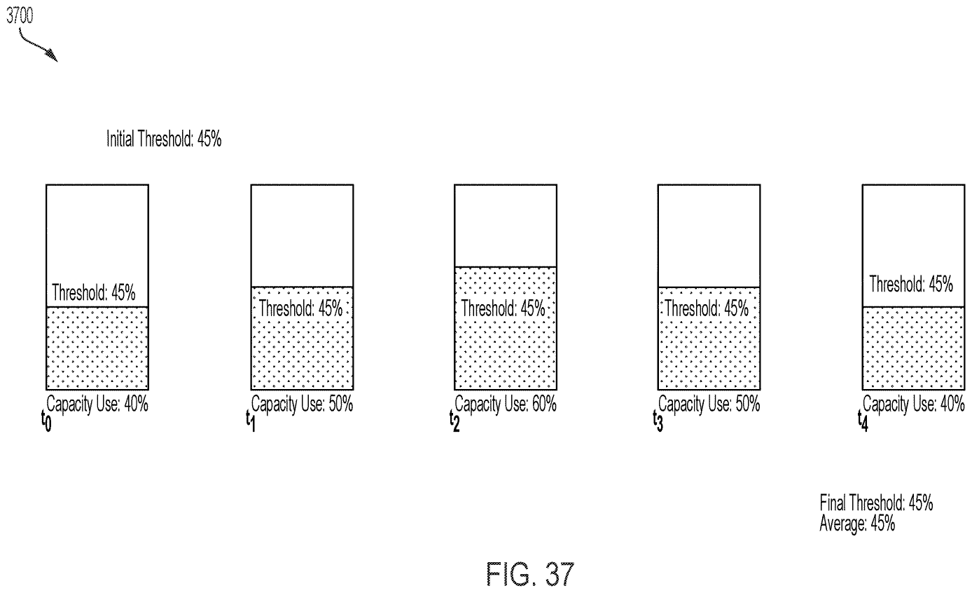

FIG. 37 shows an example of a threshold scaling feature 3700 according to examples of the present disclosure. As shown in FIG. 37, a no scaling option is shown that allows for the threshold to remain static throughout the entirety of the simulation. As shown, the initial threshold is 45%, the final threshold is 45%, and the average is 45%.

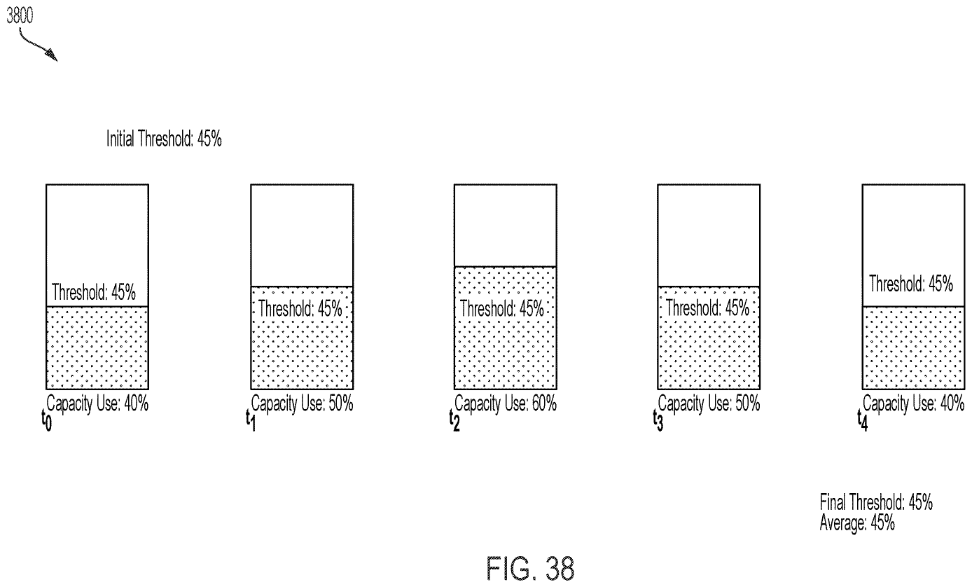

FIG. 38 shows an example of a threshold scaling feature 3800 according to examples of the present disclosure. As shown in FIG. 38, an up-scaling option is shown that allows for the threshold to grow throughout the entirety of the simulation. As shown, the initial threshold is 45%, the final threshold is 45%, and the average is 45%.

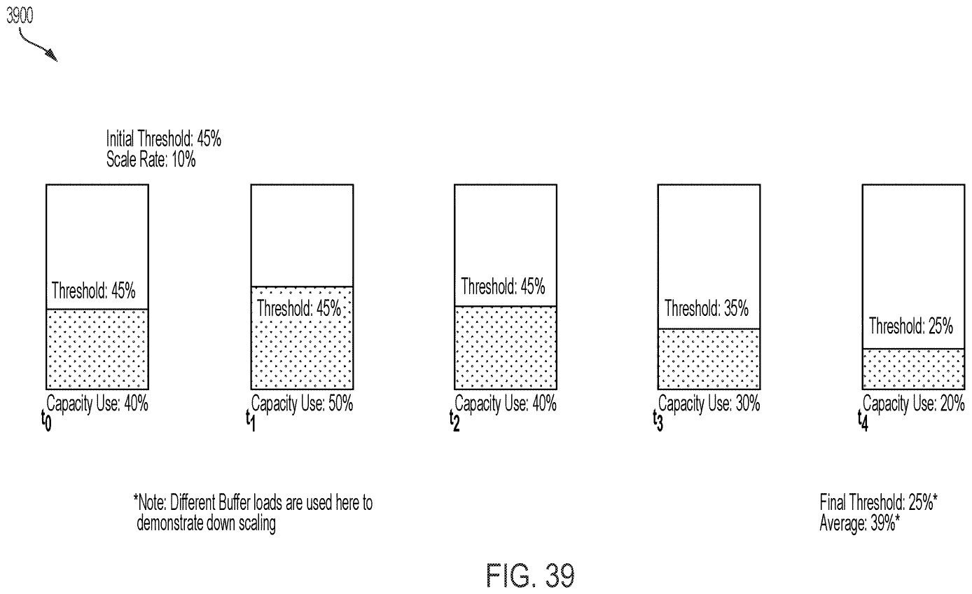

FIG. 39 shows an example of a threshold scaling feature with a down scaling option 3900 according to examples of the present disclosure. As shown in FIG. 39, a down scaling option is shown that allows for the threshold to shrink throughout the entirety of the simulation. As shown, the initial threshold is 45% with a scale rate of 10%, the final threshold is 25%, and the average is 35%.

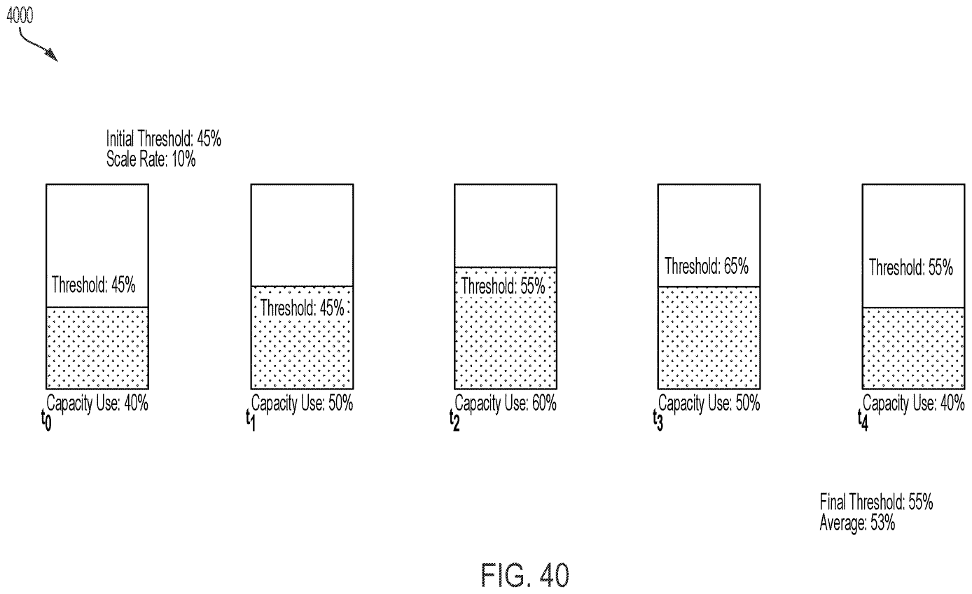

FIG. 40 shows an example of a threshold scaling feature with an up and down scaling option 4000 according to examples of the present disclosure. As shown in FIG. 40, an up and down scaling option is shown that allows for the threshold to grow and shrink throughout the entirety of the simulation. As shown, the initial threshold is 45% with a scale rate of 10%, the final threshold is 35%, and the average is 53%.

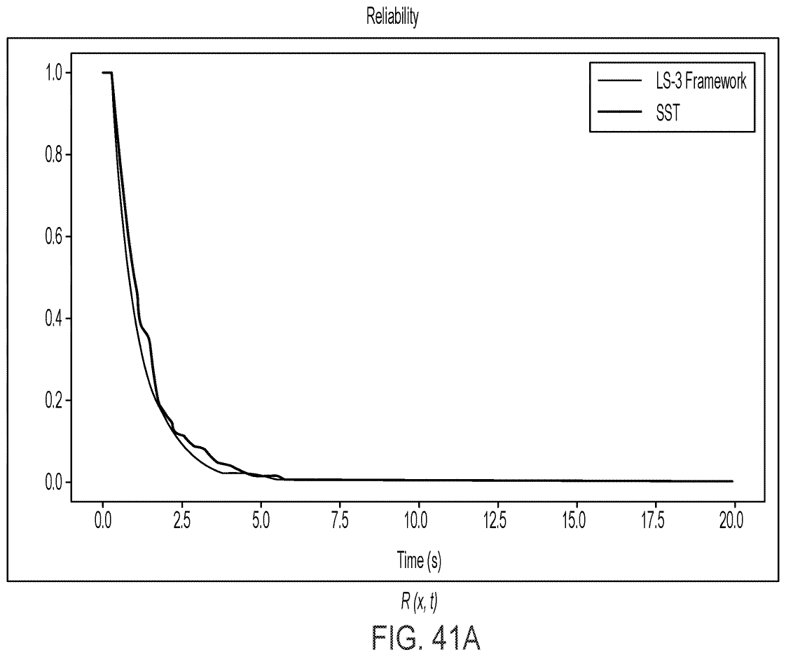

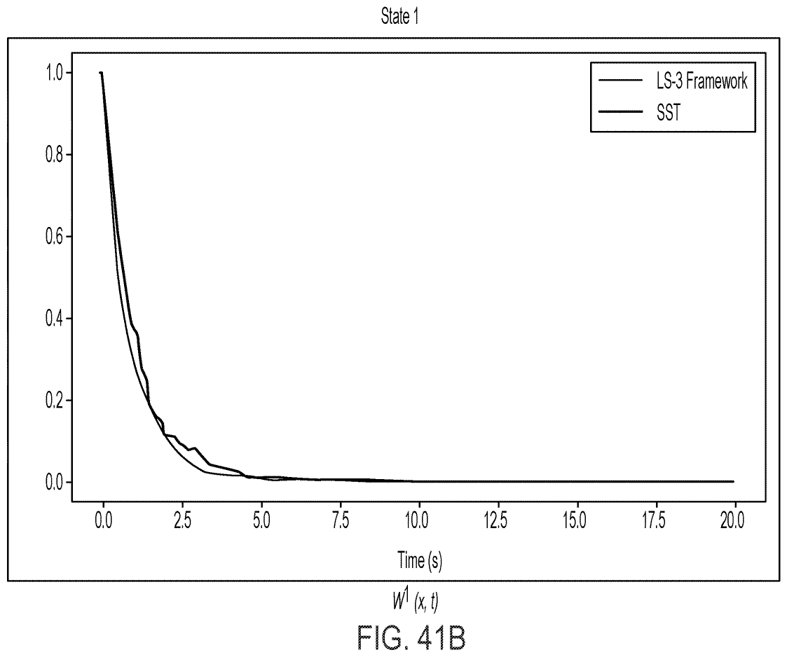

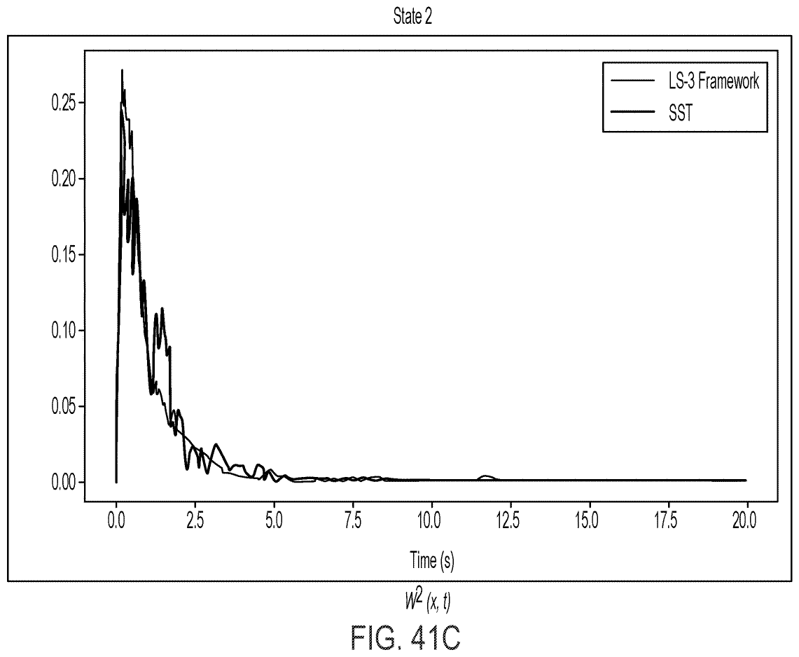

FIG. 41A, FIG. 41B, and FIG. 41C show an example of L-S3 single node local results according to examples of the present disclosure. The following are comparisons of the L-S3 Framework and SST. FIG. 41A shows a plot for Reliability (R (x,t)), FIG. 41B shows a plot for State 1 (W² (x,t)), and FIG. 41C shows a plot for State 2 (W² (x,t)).

TABLE 8
L-S3 Single Node Local Results for FIG. 41A, FIG. 41B, and FIG. 41C
Example Parameters Used

| | |
|---|---|
| φ₁ = 4 | λ = λ₁₂ = 1.3 |
| φ₂ = −1 | μ = λ₂₁ = 0.4 |

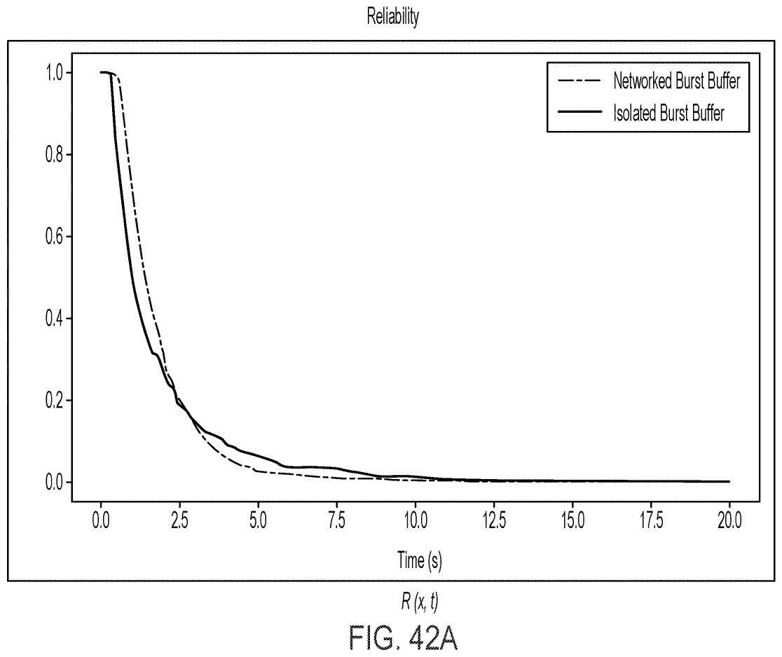

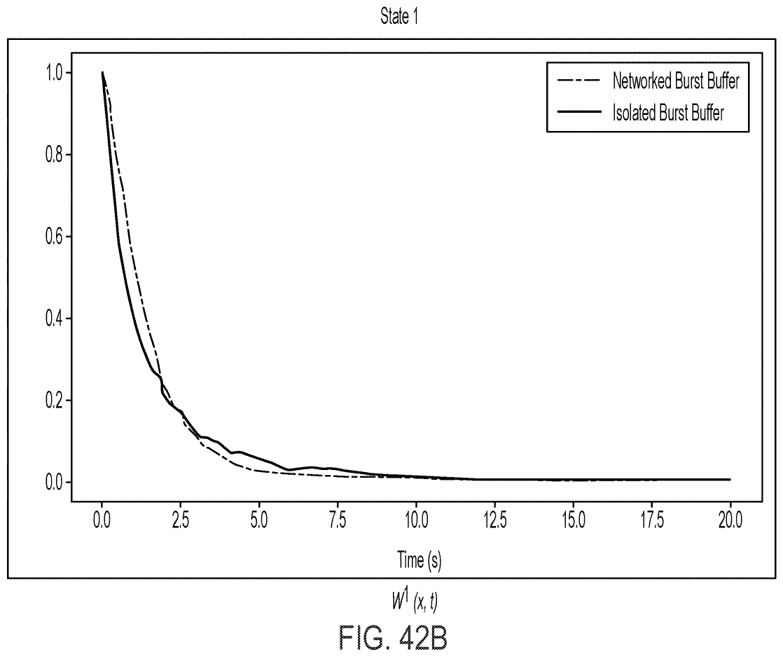

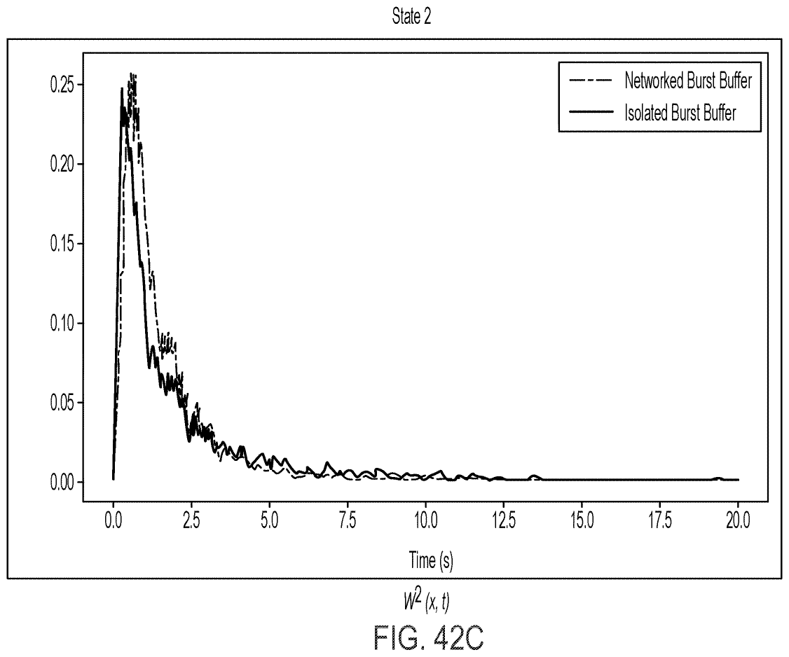

FIG. 42A, FIG. 42B, and FIG. 42C show an example of L-S3 network node local results according to examples of the present disclosure. The following are comparisons of the L-S3 Framework with an Isolated Burst Buffer and a Networked Burst Buffer. FIG. 42A shows a plot for Reliability (R (x,t)), FIG. 42B shows a plot for State 1 (W² (x,t)), and FIG. 42C shows a plot for State 2 (W² (x,t).

TABLE 9
L-S3 Single Node Local Results for FIG. 42A, FIG. 42B, and FIG. 42C
Example Parameters Used

| | |
|---|---|
| φ₁ = 4 | λ = λ₁₂ = 1.3 |
| φ₂ = −1 | μ = λ₂₁ = 0.4 |

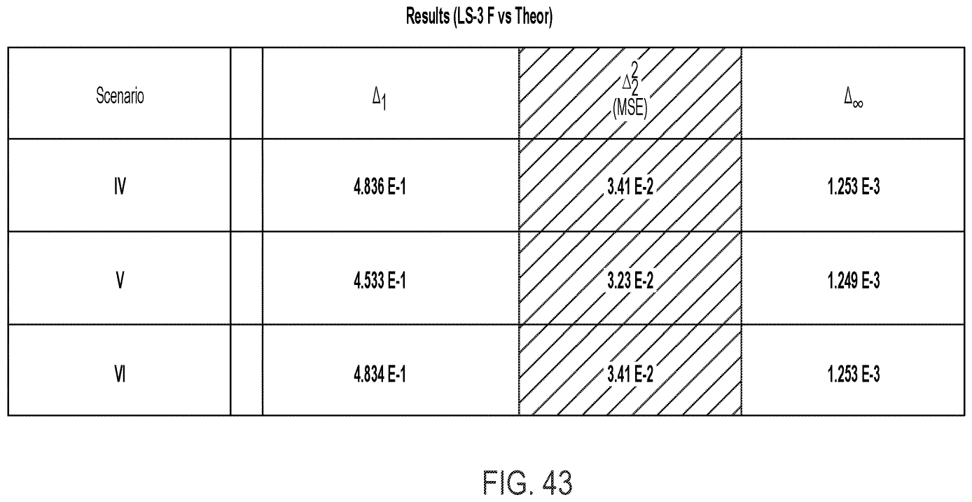

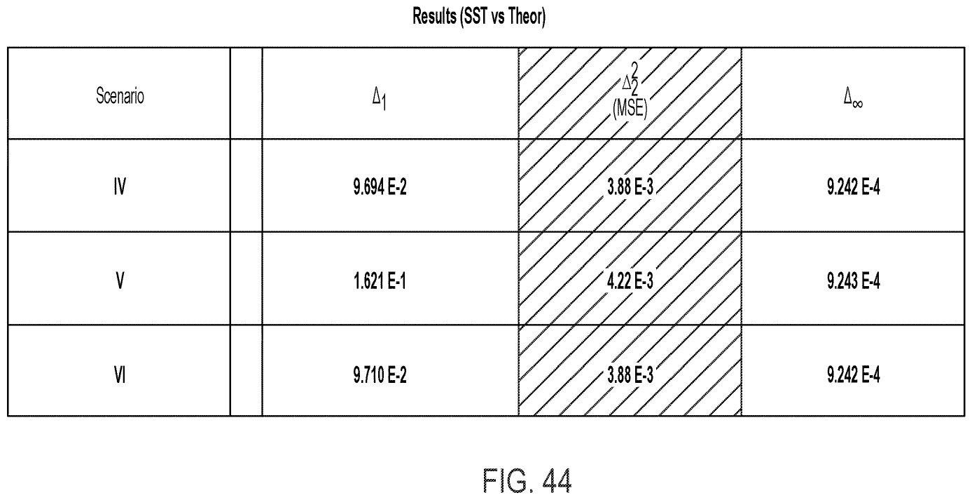

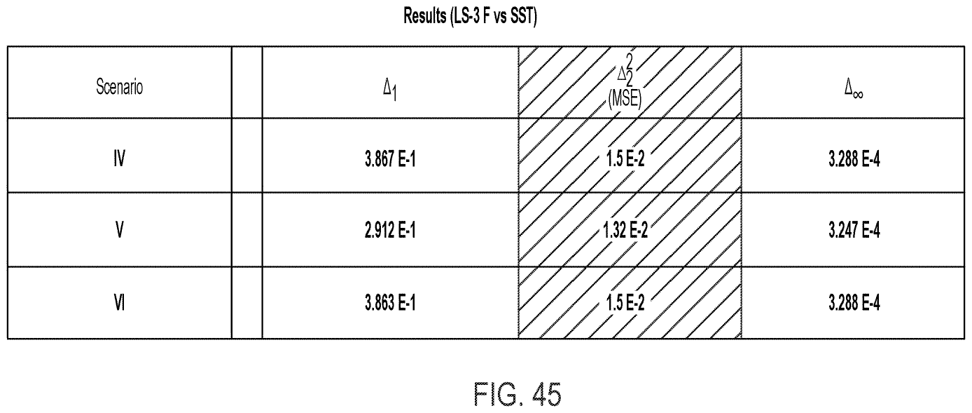

FIG. 43 shows example results (L-S3 vs theoretical) according to examples of the present disclosure. FIG. 44 shows example results (SST vs theoretical) according to examples of the present disclosure. FIG. 45 shows example results (L-S3 vs SST) according to examples of the present disclosure.

### Equations for Input:

$${W}^{m} = ( x , t ) = P \{ {Q}_{B} ( t ) \leq x \vert S ( t ) = m \} , ( m = 1 , 2 ) \qquad ( 1 )$$

$${R}_{B} ( x , t ) = P \{ {Q}_{B} ( t ) \leq x \} = {W}^{1} ( x , t ) + {W}^{2} ( x , t ) . \qquad ( 2 )$$

$${F}_{B} ( x , t ) = P \{ {Q}_{B} ( t ) > x \} = 1 - {R}_{B} ( x , t ) . \qquad ( 3 )$$

$$Notes :$$

$$m = 1 : Consider the likelihood ( probability ) that the node - local burst buffer ( BB ) is draining information to the parallel system ( PFS ) .$$

$$m = 2 : Consider the likelihood ( probability ) that the node - local burst buffer ( BB ) is receiving information from the compute node ( CN ) .$$

These equations are valid for the following cases:
Case 1: BB is initially empty at the start of each checkpoint/restart (C/R) interval. This case considers both proactive (|φ₁|≠|φ₂|) and reactive (|φ₁|=|φ₂|) cases.
Case 2: BB is initially non-empty at the start of each checkpoint/restart (C/R) interval. This case considers only reactive draining schemes (|φ₁|=|φ₂|). Specifically, this looks at the following subcases:
Subcase 1: the initial content u is greater than a given threshold x at the start of the C/R interval (u≥x).
Subcase 2: the initial content u is within a given threshold x at the start of the C/R interval (u≤x).

### Analytical Solutions Case 1:

$${W}^{1} ( \text{?} , \text{?} ) = \{ \begin{matrix}\frac{{λ}_{21} + {λ}_{12} {\text{?}}^{- ( {λ}_{12} + {λ}_{21} ) \text{?}}}{{λ}_{12} + {λ}_{21}} , & 0 < t < \text{?} / {ϕ}_{2} \\ \begin{matrix}\frac{{λ}_{21} + {λ}_{12} {e}^{- ( {λ}_{12} + {λ}_{21} ) \text{?}}}{{λ}_{12} + {λ}_{21}} - ( \frac{1}{{λ}_{21} + {λ}_{12}} ) \times \\ {e}^{- \frac{{λ}_{\text{?}}}{{ϕ}_{2}}} {\int }_{0}^{\text{?}} {f}_{1} ( t - \text{?} , \text{?} ) h ( v , x ) dv ,\end{matrix} & t > \text{?} / {ϕ}_{2}\end{matrix} \qquad ( 4 )$$

$$and$$

$${W}^{2} ( x , t ) = \{ \begin{matrix}\frac{{λ}_{12}}{{λ}_{12} + {λ}_{21}} ( 1 - {e}^{- ( {λ}_{12} + {λ}_{21} ) t} ) , & 0 < t \leq \text{?} / {ϕ}_{2} \\ \begin{matrix}\frac{{λ}_{12}}{{λ}_{12} + {λ}_{21}} ( 1 - {e}^{- ( {λ}_{12} + {λ}_{21} ) t} ) - ( \frac{{λ}_{12}}{{λ}_{12} + {λ}_{21}} ) \times \\ {e}^{- \frac{{λ}_{21}}{{ϕ}_{2}}} \times {\int }_{0}^{\text{?}} {f}_{1} ( t - v , x ) g ( v , x ) dv ,\end{matrix} & t > \text{?} / {ϕ}_{2}\end{matrix} \qquad ( 5 )$$

$$where$$

$${f}_{1} ( t , \text{?} ) = 1 - {e}^{- ( {λ}_{12} + {λ}_{21} ) ( \text{?} - \frac{\text{?}}{{ϕ}_{2}} )} , \qquad ( 6 )$$

$$h ( t , x ) = \frac{{λ}_{12} {λ}_{21} {ϕ}_{2}}{( {ϕ}_{2} - {ϕ}_{1} ) ( {λ}_{12} + {λ}_{21} )} {\text{?}}^{( - \frac{{λ}_{12} {ϕ}_{2} - {λ}_{21} {ϕ}_{1}}{{ϕ}_{1} - {ϕ}_{2}} )} \times \{ \text{?} ( \text{?} ( \text{?} , t ) ) - \frac{1}{{\text{?}}^{2} ( \text{?} , t )} ) {\text{?}}_{2} ( \text{?} ( x , t ) ) \} \text{?} \qquad ( 7 )$$

$$( \text{?} ( x , t ) - \frac{1}{\text{?} ( x , t )} ) {\text{?}}_{1} ( \text{?} ( x , t ) ) \text{?} \qquad ( 8 )$$

$$\text{?} ( x , t ) = \frac{2 t \sqrt{- {λ}_{12} {λ}_{21} {ϕ}_{1} {ϕ}_{2}}}{{ϕ}_{2} - {ϕ}_{1}} \text{?} ( x , t ) \text{?} \qquad ( 9 )$$

$$and$$

$$\text{?} ( x , t ) = \sqrt{( 1 - ( \frac{1}{{ϕ}_{1}} - \frac{1}{{ϕ}_{2}} ) \frac{\text{?}}{\text{?}} )} \text{?} \qquad ( 10 )$$

$$\text{?} \text{indicates text missing or illegible when filed}$$

and lₙ in equations (7) and (8) are the modified Bessel functions of the first kind of order n=0, 1, 2.

### Approximate Solutions Case 1:

Approximate solutions consider the following integrals in equations (4) and (5), which consists of the following relationships:

$${e}^{\frac{- {λ}_{21}}{{ϕ}_{2}} \text{?}} {\int }_{0}^{\text{?}} {f}_{1} ( t - v , x ) b ( v , x ) dv = {e}^{\frac{- {λ}_{21}}{{ϕ}_{2}} \text{?}} {\int }_{0}^{\text{?}} b ( v , x ) dv - {e}^{\{ - ( {λ}_{12} + {λ}_{21} ) + \frac{{λ}_{12}}{{ϕ}_{2}} \text{?} \}} {\int }_{0}^{\text{?}} {e}^{( {λ}_{12} + {λ}_{21} ) v} h ( v , x ) dv , \qquad ( 11 )$$

$$and$$

$${e}^{- \frac{{λ}_{21}}{{ϕ}_{2}} \text{?}} {\int }_{0}^{\text{?}} {f}_{1} ( t - v , x ) g ( v , x ) dv = {e}^{\frac{- {λ}_{21}}{{ϕ}_{2}} \text{?}} {\int }_{0}^{\text{?}} g ( v , x ) dv - {e}^{\{ - ( {λ}_{12} + {λ}_{21} ) + \frac{{λ}_{12}}{{ϕ}_{2}} \text{?} \}} {\int }_{0}^{\text{?}} {e}^{( {λ}_{12} + {λ}_{21} ) v} g ( v , x ) dv . \qquad ( 12 )$$

$$\text{?} \text{indicates text missing or illegible when filed}$$

### Approximate Solutions Case 1: Short-Time Behavior

For short-time behavior ρ=ρ(t,x)→0 as t→0. Hence, equations (11) and (12) can be expressed in terms of the following power series representations:

$${\int }_{0}^{\text{?}} \text{?} ( v , x ) dv = \frac{{λ}_{12} {λ}_{21} {ϕ}_{2}}{( {ϕ}_{2} - {ϕ}_{1} ) ( {λ}_{12} + {λ}_{21} )} {\sum }_{m = 0}^{∞} \frac{{α}^{2 m} {Ω}_{m} ( a , b , \text{?} ; x , t )}{{Γ}^{2} ( m + 1 ) {2}^{2 m}} \text{?} \qquad ( 13 )$$

$${\int }_{0}^{\text{?}} {e}^{( {λ}_{12} + {λ}_{21} ) v} \text{?} ( v , x ) dv = \frac{{λ}_{12} {λ}_{21} {ϕ}_{2}}{( {ϕ}_{2} - {ϕ}_{1} ) ( {λ}_{12} + {λ}_{21} )} {\sum }_{m = 0}^{∞} \frac{{α}^{2 m} {Ω}_{m} ( a , b , \text{?} ; x , t )}{{Γ}^{2} ( m + 1 ) {2}^{2 m}} \text{?} \qquad ( 14 )$$

$$where$$

$${Ω}_{m} ( a , b , \text{?} ; x , t ) = {\sum }_{m = 0}^{∞} ( \begin{matrix}m \\ k\end{matrix} ) \frac{{( 2 bx )}^{m - k} ( m + k ) \text{?}}{{a}^{m + k + 1}} \times \{ ( 1 - {e}^{- \text{?} t} {\sum }_{l = 0}^{m + k} ( \frac{{( \text{?} )}^{\text{?}}}{\text{?}} ) - \frac{{α}^{2}}{4 ( m + 1 ) ( m + 2 )} \times {\sum }_{k = 0}^{m} ( \begin{matrix}m \\ k\end{matrix} ) \frac{{( 2 bx )}^{m - k} ( m + k + 2 ) \text{?}}{{a}^{m + k + 3}} ( 1 - {e}^{- \text{?}} {\sum }_{\text{?} = 0}^{m + k + 2} ( \frac{{( \text{?} )}^{\text{?}}}{\text{?}} ) \} \text{?} \qquad ( 15 )$$

$$\text{?} \text{indicates text missing or illegible when filed}$$

and the constants a, â, b, and α are defined as

$$\text{?} = \frac{{λ}_{12} {ϕ}_{2} - {λ}_{21} {ϕ}_{1}}{{ϕ}_{2} - {ϕ}_{1}} \text{?} \text{?} = \frac{{λ}_{12} {ϕ}_{1} - {λ}_{21} {ϕ}_{2}}{{ϕ}_{2} - {ϕ}_{1}} \text{?} \qquad ( 16 )$$

$$b = - \frac{1}{2} ( \frac{1}{{ϕ}_{1}} - \frac{1}{{ϕ}_{2}} ) \text{?} and {\text{?}}^{2} = - \frac{4 {λ}_{12} {λ}_{21} {ϕ}_{1} {ϕ}_{2}}{{( {ϕ}_{2} - {ϕ}_{1} )}^{2}} . \qquad ( 17 )$$

$$Analogously ,$$

$${\int }_{0}^{\text{?}} g ( v , x ) dv = 1 + \frac{{λ}_{12} {λ}_{21} \text{?}}{{ϕ}_{2} - {ϕ}_{1}} {\sum }_{m = 0}^{∞} \frac{{\text{?}}^{2 m} {χ}_{\text{?}} ( a , b , a , \text{?} , t )}{{2}^{2 m} Γ ( m + 1 ) Γ ( m + 2 )} , \qquad ( 18 )$$

$${\int }_{0}^{\text{?}} {e}^{( {λ}_{12} + {λ}_{21} ) v} g ( v , x ) dv = 1 + \frac{{λ}_{12} {λ}_{21} \text{?}}{{ϕ}_{2} - {ϕ}_{1}} {\sum }_{m = 0}^{∞} \frac{{\text{?}}^{2 m} {χ}_{m} ( a , b , \text{?} , \text{?} , t )}{{2}^{2 m} Γ ( m + 1 ) Γ ( m + 2 )} , \qquad ( 19 )$$

$$where$$

$${χ}_{m} ( a , b , \text{?} ; \text{?} , t ) = {\sum }_{m = 0}^{∞} ( \begin{matrix}m \\ k\end{matrix} ) \frac{{( 2 bx )}^{m - k} ( m + k ) \text{?}}{{a}^{m + k + 1}} \times ( 1 - {e}^{- \text{?} t} {\sum }_{\text{?} = 0}^{m + k} ( \frac{{( \text{?} t )}^{\text{?}}}{\text{?}} ) , \qquad ( 20 )$$

$$\text{?} \text{indicates text missing or illegible when filed}$$

and the constants a, â, b, and α are defined by equations (16) and (17), respectively.

### Approximate Solutions Case 1: Long-Time Behavior

For long-time behavior ρ=ρ(t,x)→∞ as t→∞. This results in the following asymptotic representations:

$$\text{?} \qquad ( 21 )$$

$$\text{?} \qquad ( 22 )$$

$$and$$

$$\text{?} \qquad ( 23 )$$

$$\text{?} \qquad ( 24 )$$

$$\text{?} \text{indicates text missing or illegible when filed}$$

when the constant a, â, b, and α are defined by equations (16) and (17), respectively.
   Approximate solutions Case 1: Comprehensive Expansion Method

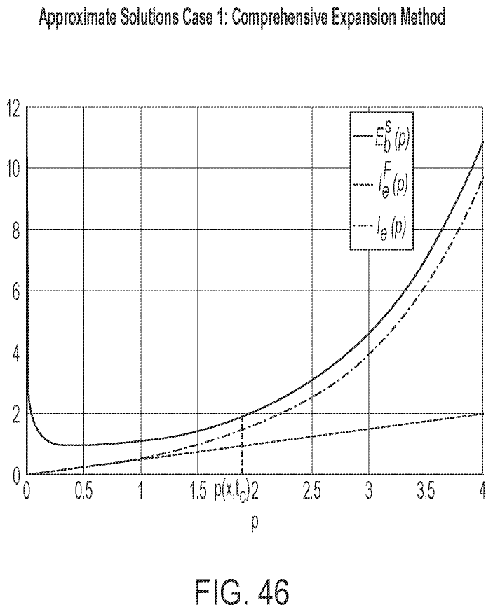

FIG. 46 show a plot of power and asymptotic expansions of the Bessel Function l₀.

The critical point t_{c} is estimated from the following:

$$\text{?} \qquad ( 25 )$$

$$\text{?} \text{indicates text missing or illegible when filed}$$

where, lₙ(ρ(x, t_{C})) is the modified Bessel function of order n=0, 1.

$${I}_{n}^{P} ( ρ ( x , {t}_{c} ) )$$

is the power series of the modified Bessel function of order n=0, 1,

$${I}_{n}^{A} ( ρ ( x , {t}_{c} ) )$$

is the asymptotic series of the modified Bessel function of order n=0, 1, and ϵ=1×10⁻⁶ is the error tolerance.

This critical point is the transition point between power series and asymptotic expansion. Next, the power series and asymptotic representations of equations (11) and (12) are fused into equations (4) and (5) to consider the behavior for all t.

Analytical Solutions Case 2 [u>x]

$$\text{?}$$

$$\text{?} \qquad ( 26 )$$

$$\text{?}$$

$$\text{?} \qquad ( 27 )$$

$$and$$

$$\text{?} \qquad ( 28 )$$

$$\text{?}$$

$$\text{?} \qquad ( 29 )$$

$$and$$

$$\text{?} \qquad ( 30 )$$

$$where$$

$$\text{?} \qquad ( 31 )$$

$$\text{?} \qquad ( 32 )$$

$$\text{?} \qquad ( 33 )$$

$$\text{?} \qquad ( 34 )$$

$$and$$

$$\text{?} \qquad ( 35 )$$

$$\text{?} \text{indicates text missing or illegible when filed}$$

and lₙ are the modified Bessel functions of the first kind of order n=0, 1.
   Approximate solutions Case 1 [u>x]: Short-Time Behavior

$$\text{?}$$

$$\text{?} \qquad ( 36 )$$

$$\text{?}$$

$$\text{?} \qquad ( 37 )$$

$$\text{?} \qquad ( 38 )$$

$$\text{?}$$

$$\text{?} \qquad ( 39 )$$

$$and$$

$$\text{?} \qquad ( 40 )$$

$$where$$

$$\text{?} \qquad ( 41 )$$

$$and$$

$$\text{?} \qquad ( 42 )$$

$$\text{?} \text{indicates text missing or illegible when filed}$$

Note: Ωₖ(t; \tilde{v}₀, a) and Ωₖ(t; \tilde{v}₀, −a) can be found by substituting \tilde{v}₀ for v₀ into equations (41) and (42), respectively.
   Approximate Solutions Case 2 [u>x]: Long-Time Behavior

$$\text{?} \qquad ( 43 )$$

$$\text{?} \qquad ( 44 )$$

$$where$$

$$\text{?} \qquad ( 45 )$$

$$\text{?} \qquad ( 46 )$$

$$\text{?} \qquad ( 47 )$$

$$\text{?} \qquad ( 48 )$$

$$\text{?} \text{indicates text missing or illegible when filed}$$

xₖ (t; \tilde{v}₀, a), xₖ (t; \tilde{v}₀, −a), x₋₁ (t; \tilde{v}₀, a) and x₋₁ (t; \tilde{v}₀, −a) can be found by substituting \tilde{v}₀ for v₀ into equations (45)-(48), respectively.
   Approximate Solutions Case 2 [u>x]: Comprehensive Expansion

The critical point t_{c} is estimated from the following:

$$\text{?} \qquad ( 49 )$$

$$\text{?} \qquad ( 50 )$$

$$\text{?} \text{indicates text missing or illegible when filed}$$

where lₙ (y(t_{C}) and lₙ(\tilde{y}(\tilde{t}_{C})) are the modified Bessel functions of order n=0, 1,

$${I}_{n}^{P} ( y ( {t}_{c} ) ) and {I}_{n}^{P} ( \overline{y} ( {\overline{t}}_{c} ) )$$

are the power series of the modified Bessel functions of order n=0, 1,

$${I}_{n}^{A} ( y ( {t}_{c} ) ) and {I}_{n}^{A} ( \overline{y} ( {\overline{t}}_{c} ) )$$

are the asymptotic series of the modified Bessel functions of order n=0, 1, and ϵ=1×10⁻⁶ is the error tolerance.

This critical point is the transition point between power series and asymptotic expansion. Next, the power series and asymptotic representations of equations (11) and (12) are fused into equations (26)-(30) to consider the behavior for all t.

Analytical Solutions Case 2: [u≤x]

$$\text{?}$$

$$\text{?} \qquad ( 51 )$$

$$\text{?} \qquad ( 52 )$$

$$\text{?}$$

$$\text{?} \qquad ( 53 )$$

$$\text{?}$$

$$\text{?} \qquad ( 54 )$$

$$\text{?}$$

$$\text{?} \qquad ( 55 )$$

$$\text{?} \qquad ( 56 )$$

$$where$$

$$\text{?} \qquad ( 57 )$$

$$\text{?} \qquad ( 58 )$$

$$\text{?} \qquad ( 59 )$$

$$\text{?} \qquad ( 60 )$$

$$\text{?} \qquad ( 61 )$$

$$\text{?} \qquad ( 62 )$$

$$\text{?} \qquad ( 63 )$$

$$\text{?} \qquad ( 64 )$$

$$\text{?} \qquad ( 65 )$$

$$\text{?} \qquad ( 66 )$$

$$\text{?} \qquad ( 67 )$$

$$\text{?} \qquad ( 68 )$$

$$\text{?} \qquad ( 69 )$$

$$\text{?} \qquad ( 70 )$$

$$\text{?} \qquad ( 71 )$$

$$\text{?} \qquad ( 72 )$$

$$\text{?} \qquad ( 73 )$$

$$\text{?} \qquad ( 74 )$$

$$\text{?} \qquad ( 75 )$$

$$\text{?} \qquad ( 76 )$$

$$\text{?} \qquad ( 77 )$$

$$\text{?} \qquad ( 78 )$$

$$\text{?} \qquad ( 79 )$$

$$\text{?} \qquad ( 80 )$$

$$\text{?} \qquad ( 81 )$$

$$\text{?} \qquad ( 82 )$$

$$\text{?} \qquad ( 83 )$$

$$\text{?} \qquad ( 84 )$$

$$\text{?} \qquad ( 85 )$$

$$\text{?} \qquad ( 86 )$$

$$\text{?} \qquad ( 87 )$$

$$\text{?} \qquad ( 88 )$$

$$\text{?} \qquad ( 89 )$$

$$\text{?} \text{indicates text missing or illegible when filed}$$

### Approximate Solutions for Bessel Functions

Given the modified Bessel function lₙ(y), the power series

$${I}_{n}^{p}$$

(y) (i.e., as y→0) is given by

$$\text{?} \qquad ( 90 )$$

$$\text{?} \text{indicates text missing or illegible when filed}$$

The asymptotic expansion for l₀(y) (it, as y→∞) is given by

$$\text{?} \qquad ( 91 )$$

$$\text{?} \text{indicates text missing or illegible when filed}$$

The asymptotic expansion for l₀(y) (i.e., as y→∞) for n≥1 is given by

$$\text{?} \qquad ( 92 )$$

$$\text{?} \text{indicates text missing or illegible when filed}$$

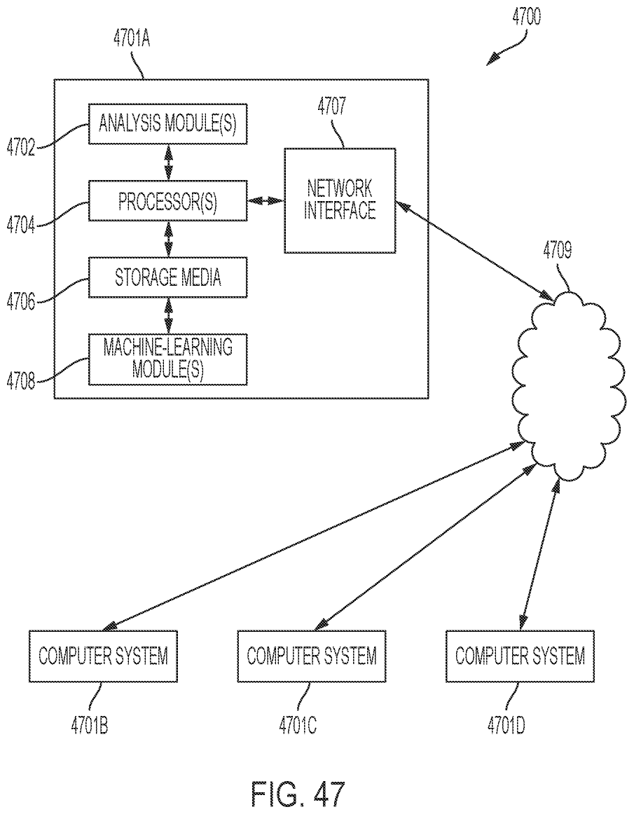

In some embodiments, any of the methods of the present disclosure may be executed by a computing system. FIG. 47 illustrates an example of such a computing system 4700, in accordance with some embodiments. The computing system 4700 may include a computer or computer system 4701A, which may be an individual computer system 4701A or an arrangement of distributed computer systems. The computer system 4701A includes one or more analysis module(s) 4702 configured to perform various tasks according to some embodiments, such as one or more methods disclosed herein. To perform these various tasks, the analysis module 4702 executes independently, or in coordination with, one or more processors 4704, which is (or are) connected to one or more storage media 4706. The processor(s) 4704 is (or are) also connected to a network interface 4707 to allow the computer system 4701A to communicate over a data network 4709 with one or more additional computer systems and/or computing systems, such as 4701B, 4701C, and/or 4701D (note that computer systems 4701B, 4701C and/or 4701D may or may not share the same architecture as computer system 4701A, and may be located in different physical locations, e.g., computer systems 4701A and 4701B may be located in a processing facility, while in communication with one or more computer systems such as 4701C and/or 4701D that are located in one or more data centers, and/or located in varying countries on different continents). A processor can include a microprocessor, microcontroller, processor module or subsystem, programmable integrated circuit, programmable gate array, or another control or computing device.

The storage media 4706 can be implemented as one or more computer-readable or machine-readable storage media. The storage media 4706 can be connected to or coupled with a neuromodulation machine learning module(s) 4708. Note that while in the example embodiment of FIG. 47 storage media 4706 is depicted as within computer system 4701A, in some embodiments, storage media 4706 may be distributed within and/or across multiple internal and/or external enclosures of computing system 4701A and/or additional computing systems. Storage media 4706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions or located at a remote site from which machine-readable instructions can be downloaded over a network for execution.

It should be appreciated that computing system 4700 is only one example of a computing system, and that computing system 4700 may have more or fewer components than shown, may combine additional components not depicted in the example embodiment of FIG. 47, and/or computing system 4700 may have a different configuration or arrangement of the components depicted in FIG. 47. The various components shown in FIG. 47 may be implemented in hardware, software, or a combination of both hardware and software, including one or more signal processing and/or application specific integrated circuits.

Further, the steps in the processing methods described herein may be implemented by running one or more functional modules in an information processing apparatus such as general purpose processors or application specific chips, such as ASICs, FPGAs, PLDs, or other appropriate devices. These modules, combinations of these modules, and/or their combination with general hardware are all included within the scope of protection of the invention.

The various above-described factors, models and/or other interpretation aids may be refined in an iterative fashion; this concept is applicable to embodiments of the present methods discussed herein. This can include use of feedback loops executed on an algorithmic basis, such as at a computing device (e.g., computing system 4700, FIG. 47), and/or through manual control by a user who may make determinations regarding whether a given step, action, template, model, or set of curves has become sufficiently accurate for the evaluation of the signal(s) under consideration.

In summary, a real-time large-scale simulation framework for HPC intermediary storage architectures is disclosed that considers real-time data flow behavior within intermediary storage elements, as known as burst buffers (BBs) and realistically considers the dynamic data flow impact through the compute nodes via the network, which also impact the BB, is customizable to various HPC storage architectures and use cases, is user-friendly, and is agnostic. This simulator is able to provide robust reliability analysis metric for node-local storage architectures and the result show an accuracy between O(10⁻²) and O(10⁻⁴). The simulator can also be applied to simulate other distributed resource allocation use cases, such as various aspects of 5G networks.

Different examples of the apparatus(es) and method(s) disclosed herein include a variety of components, features, and functionalities. It should be understood that the various examples of the apparatus(es) and method(s) disclosed herein may include any of the components, features, and functionalities of any of the other examples of the apparatus(es) and method(s) disclosed herein in any combination, and all of such possibilities are intended to be within the scope of the present disclosure. Many modifications of examples set forth herein will come to mind to one skilled in the art to which the present disclosure pertains having the benefit of the teachings presented in the foregoing descriptions and the associated drawings.

Reference herein to “one example” means that one or more feature, structure, or characteristic described in connection with the example is included in at least one implementation. The phrase “one example” in various places in the specification may or may not be referring to the same example. As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Notwithstanding that the numerical ranges and parameters setting forth the broad scope of the embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

Furthermore, to the extent that the terms “including”, “includes”, “having”, “has”, “with”, or variants thereof are used in either the detailed description and the claims, such terms are intended to be inclusive in a manner similar to the term “comprising.” As used herein, the phrase “one or more of”, for example, A, B, and C means any of the following: either A, B, or C alone; or combinations of two, such as A and B, B and C, and A and C; or combinations of A, B and C.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method comprising:
initializing a node-local burst buffer (“BB”) component, a computer-node component, a parallel file system component, a remote-shared burst buffer component, a node-local BB network configuration, and a remote-shared burst buffer network configuration,
determining a rate of data flowing condition to alter between states to control a rate of data flowing through a computer network system;
determining a data to move condition to allow data to move from the computer node to the burst buffer or the burst buffer to the parallel file system;
determining a simulation condition for a simulation to begin, reset, pause, or terminate;
performing a simulation flow using networked compute nodes in a networked simulation; and
generating a computer output based on the simulation flow for network analysis.

2. The method of claim 1, wherein the node-local burst buffer component is initialized with a user provided system clock rate, bandwidth values for connection to the compute node and parallel file system, max capacity, starting load, threshold, scaling option, scaling rate.

3. The method of claim 1, wherein the computer-node component is initialized with a user provided system clock rate, random number generator seeds, bandwidth values for connection to the burst buffer, the rate that data flows into the burst buffer from the compute node (CN), the rate that data leaves the burst buffer to the parallel file system (PFS) representing permanent storage, the intermediate time intervals and the number of times that the content flows from the compute node to the BB, the intermediate time intervals and the number of times that the content flows the BB to the PFS.

4. The method of claim 1, wherein the computer output comprises one or more of the following: one or more computer generated displays that show a capacity at an end of each simulation to a user along with statistics on how often systems threshold was exceeded and for how long the threshold was exceeded for a duration of the simulation; a file with a new-line delimiter of values that represent a reliability rate of the burst buffer at an end of programs runtime; a file with a new-line delimiter of values that represent a load of the burst buffer throughout one simulation; a file with a new-line delimiter of values for how often the simulation is in a compute state while under a user defined threshold; a file with a new-line delimiter of values for how often the simulation is in an I/O state and while under the user defined threshold; or a file with a comma delimiter of values representing a rate that data flows into the burst buffer from the compute node (CN), a rate that data leaves the burst buffer to a parallel file system (PFS).

5. The method of claim 1, wherein the remote-shared burst buffer component is initialized with a user-defined number of CNs, system clock rate, bandwidth values from the CNs to the BB, bandwidth values from the BB to the PFS, BB max capacity, BB starting load, BB threshold, a scaling option, and a scaling rate.

6. The method of claim 1, wherein the node-local BB network configuration is initialized with a user provided network topology, network size, network configuration, link bandwidth, link latency, flit size, bandwidth, input latency, output latency, input buffer size, output buffer size, and message size and the parallel file system component is initialized with a user provided system clock rate.

7. The method of claim 1, wherein the remote-shared BB network configuration is initialized with a user provided network topology, network size, network configuration, link bandwidth, link latency, flit size, bandwidth, input latency, output latency, input buffer size, output buffer size, and message size.

8. The method of claim 1, wherein the performing uses a multiply-with-carry pseudo random number generator with an exponential distribution for determining when to alter between states to control the rate of data flowing through the system.

9. The method of claim 8, wherein the pseudo random number generator is a Marsaglia-based random number generator.

10. The method of claim 1, wherein the performing uses a two-state cycle to determine when to allow data to move from the compute node to the burst buffer, or the burst buffer to the parallel file system at a rate equal to the bandwidth available between the communicating components.

11. The method of claim 1, wherein the performing uses the node-local BB to dictate simulation flow in its node-local simulation by determining when the simulation can begin, reset, pause, and terminate.

12. The method of claim 1, wherein the performing uses the remote-shared BB to dictate simulation flow in its node-local simulation by determining when the simulation can begin, reset, pause, and terminate.

13. A computer system comprising:
a hardware processor;
a non-transitory computer-readable medium comprising instructions for performing a method comprising:
initializing a node-local burst buffer (“BB”) component, a computer-node component, a parallel file system component, a remote-shared burst buffer component, a node-local BB network configuration, and a remote-shared burst buffer network configuration,
determining a rate of data flowing condition to alter between states to control a rate of data flowing through a computer network system;
determining a data to move condition to allow data to move from the computer node to the burst buffer or the burst buffer to the parallel file system;
determining a simulation condition for a simulation to begin, reset, pause, or terminate;
performing a simulation flow using networked compute nodes in a networked simulation; and
generating a computer output based on the simulation flow for network analysis.

14. The computer system of claim 13, wherein the node-local burst buffer component is initialized with a user provided system clock rate, bandwidth values for connection to the compute node and parallel file system, max capacity, starting load, threshold, scaling option, scaling rate.

15. The computer system of claim 13, wherein the computer-node component is initialized with a user provided system clock rate, random number generator seeds, bandwidth values for connection to the burst buffer, the rate that data flows into the burst buffer from the compute node (CN), the rate that data leaves the burst buffer to the parallel file system (PFS) representing permanent storage, the intermediate time intervals and the number of times that the content flows from the compute node to the BB, the intermediate time intervals and the number of times that the content flows the BB to the PFS.

16. The computer system of claim 13, wherein the parallel file system component is initialized with a user provided system clock rate.

17. The computer system of claim 13, wherein the remote-shared burst buffer component is initialized with a user-defined number of CNs, system clock rate, bandwidth values from the CNs to the BB, bandwidth values from the BB to the PFS, BB max capacity, BB starting load, BB threshold, a scaling option, and a scaling rate.

18. The computer system of claim 13, wherein the node-local BB network configuration is initialized with a user provided network topology, network size, network configuration, link bandwidth, link latency, flit size, bandwidth, input latency, output latency, input buffer size, output buffer size, and message size.

19. A non-transitory computer-readable medium comprising instructions for performing a method comprising:
initializing a node-local burst buffer (“BB”) component, a computer-node component, a parallel file system component, a remote-shared burst buffer component, a node-local BB network configuration, and a remote-shared burst buffer network configuration,
determining a rate of data flowing condition to alter between states to control a rate of data flowing through a computer network system;
determining a data to move condition to allow data to move from the computer node to the burst buffer or the burst buffer to the parallel file system;
determining a simulation condition for a simulation to begin, reset, pause, or terminate;
performing a simulation flow using networked compute nodes in a networked simulation; and
generating a computer output based on the simulation flow for network analysis.

20. The non-transitory computer-readable medium of claim 1 non-transitory computer-readable medium9, wherein the node-local burst buffer component is initialized with a user provided system clock rate, bandwidth values for connection to the compute node and parallel file system, max capacity, starting load, threshold, scaling option, scaling rate.
